(19) United States
(12) Patent Application Publication
(10) Pub. No.: US 2025/0081068 A1
(43) Pub. Date: Mar. 6, 2025

(54) RADIO STATION SELECTION METHOD AND RADIO STATION SELECTION SYSTEM

(71) Applicant: NIPPON TELEGRAPH AND TELEPHONE CORPORATION, Tokyo (JP)

(72) Inventors: Hideyuki TSUBOI, Musashino-shi, Tokyo (JP); Yutaka KUNO, Musashino-shi, Tokyo (JP); Naoki KITA, Musashino-shi, Tokyo (JP); Takeshi ONIZAWA, Musashino-shi, Tokyo (JP)

(73) Assignee: NIPPON TELEGRAPH AND TELEPHONE CORPORATION, Tokyo (JP)

(21) Appl. No.: 18/727,331

(22) PCT Filed: Jan. 17, 2022
(86) PCT No.: PCT/JP2022/001342

§ 371 Date: Jul. 8, 2024

(51) Int. Cl. H04W 36/30; H04B 17/309; H04B 17/391

(52) U.S. Cl. CPC H04W 36/30; H04B 17/347; H04B 17/3913

(57) ABSTRACT

A radio station selection method includes an acquisition step of acquiring image information indicating an image obtained by capturing a space through which a radio wave is able to propagate in communication between a first radio station and a second radio station, an estimation step of estimating a propagation loss of a radio wave in the communication on the basis of the image information acquired in the acquisition step, and a determination step of determining whether or not to switch a radio station to which the first radio station is connected for communication from the second radio station to a third radio station on the basis of the propagation loss estimated in the estimation step.

### TECHNICAL FIELD

The present invention relates to a radio station selection method and a radio station selection system.

### BACKGROUND ART

In recent years, terminal devices capable of performing wireless communication such as mobile terminals, such as smartphones and tablet terminals that can also be used outdoors, and Internet of Things (IoT) terminals have been widely spread. A radio base station (hereinafter referred to as a “base station”) to which such a terminal device (hereinafter referred to as a “terminal station”) is connected for communication is installed at a plurality of places such as a utility pole and a wall surface of a building, for example. In order to stably transmit and receive radio waves and achieve higher communication quality in wireless communication between the base station and the terminal station, it is basically preferable that the terminal station is connected for communication to a closer base station. However, in a case where the terminal station is a mobile terminal, the distance between the base station and the terminal station changes from moment to moment, and thus the base station located closer to the terminal station may change with time.

Further, there may be an object that blocks radio waves (hereinafter referred to as a “shielding object”) between the base station and the terminal station. The shielding object is, for example, a building such as a building or a house, an elevated road, a signboard or a sign, a tree, or a vehicle such as a stopped automobile, or the like. In this case, in order to achieve higher communication quality, it is necessary to determine the presence or absence of a line of sight between the base station and the terminal station in consideration of the presence of a shielding object, and to appropriately select a base station to which the terminal station is to be connected for communication. In particular, in a case where the shielding object is an object that moves or changes, for example, a stopped vehicle, a tree, or the like, the base station to be selected may change with time.

Conventionally, a plurality of methods has been used as a method for determining a line of sight between the base station and the terminal station. For example, as the easiest line-of-sight determination method, there is a line-of-sight determination method based on a communication distance. In the line-of-sight determination method based on a communication distance, it is determined that there is a line of sight when a distance between a possible installation position of a base station and a representative point is within a predetermined communicable distance, and it is determined that there is no line of sight when the distance is longer than the communicable distance. However, this line-of-sight determination method based only on the communication distance has a problem that the determination accuracy is low.

Further, a line-of-sight determination method based on map information is also a relatively easy method. The map information includes information indicating, for example, outlines such as outer walls of buildings existing in the evaluation target area. In the line-of-sight determination method based on the map information, on a two-dimensional map, it is determined that there is a line of sight when a line segment connecting a possible installation position of a base station and a representative point does not intersect with an outline of a building, and it is determined that there is no line of sight when the line segment intersects with an outline of a building. However, since the map information does not include information about the presence of an object (for example, trees, signboards, road signs, and the like) that obstructs the line of sight other than buildings, the line-of-sight determination method based on the map information also has a problem that the determination accuracy is not high.

Further, as a method of determining the presence or absence of a line of sight between the base station and the terminal station with higher accuracy, there is a line-of-sight determination method using three-dimensional point cloud data obtained by capturing an image of a space (see, for example, Patent Literature 1). In this line-of-sight determination method, first, for example, a vehicle or the like equipped with a mobile mapping system (MMS) is caused to travel along a road in an evaluation target area such as a residential area. Thus, this line-of-sight determination method acquires three-dimensional point cloud data indicating the positions of all objects existing in the evaluation target area. Then, in this line-of-sight determination method, line-of-sight determination is performed on the basis of point cloud data existing in a space between the position of the base station and the position where the terminal station can exist, and communication availability between the base station and the terminal station is determined.

In the line-of-sight determination method using the three-dimensional point cloud data described above, for example, a Fresnel zone formed in wireless communication between the base station and the terminal station is assumed as the space described above. Specifically, in this line-of-sight determination method, for example, the presence or absence of a line of sight between the base station and the terminal station is determined according to the number of pieces of point cloud data included in the space of the Fresnel zone. In this way, in order to perform the line-of-sight determination with higher accuracy on the basis of the three-dimensional point cloud data, it is necessary to sufficiently obtain the point cloud data indicating the position of the shielding object existing in the evaluation target area in advance.

Further, as a method of determining a line of sight with higher accuracy using the three-dimensional point cloud data, there is a line-of-sight determination method considering a shielding rate (see, for example, Non Patent Literature 1). The shielding rate mentioned here is an index value indicating how much the line of sight between the base station and the terminal station is shielded. In other words, it can be said that the shielding rate is an index indicating how much the shielding object influences the wireless communication performed between the base station and the terminal station, which leads to degradation of communication quality. The line-of-sight determination method in consideration of the shielding rate performs line-of-sight determination by, for example, calculating a loss amount of a propagation loss of a radio wave from the shielding rate calculated on the basis of acquired point cloud data, and designing a line of wireless communication between the base station and the terminal station on the basis of the calculated loss amount.

However, since the above-described line-of-sight determination method using three-dimensional point cloud data has a large amount of calculation and a high system load related to calculation processing, it is currently limited to line-of-sight determination using, for example, only point cloud data on some cross-sections of the Fresnel zone, and a stage of evaluating a cumulative line of sight in the entire propagation path of the radio wave has not been reached. Thus, this line-of-sight determination method using three-dimensional point cloud data also has a problem that determination accuracy is not very high.

Further, in recent years, an artificial satellite such as a low earth orbiting satellite (LEO) is also used as a base station in order to widen a communication area. Furthermore, a plan and a demonstration experiment for constructing a communication network in the stratosphere by using a high altitude platform station (HAPS) as a base station are also in progress (see, for example, Non Patent Literatures 2 and 3). In recent years, research on such a non-terrestrial network (NTN) has been actively conducted. The NTN is a communication network that extends a communication area not only to the ground but also to any place such as the sky, the sea, and space. Studies have been conducted to apply such an NTN to wireless communication for various purposes, such as achievement of stable wireless communication at the time of disaster and achievement of large-capacity wireless communication in an aircraft (see, for example, Non Patent Literature 4).

### CITATION LIST

### Patent Literature

Patent Literature 1: JP 2020-107955 A

### Non Patent Literature

Non Patent Literature 1: “TsuKuBa nenshi Miriha tai chikyoku sekkei shien tool (in Japanese) (TsuKuBa history millimeter wave band station installation design support tool)”, NTT Access Service Systems Laboratories, 2019, [searched on Dec. 17, 2021], the Internet (URL: https://www.rd.ntt/as/history/pdf/wireless/wi0212.pdf)
Non Patent Literature 2: “Joku karano tsushin area ka ni muketa 39 GHz band no denpa denpan sokutei jissho jikken˜HAPS niyoru shigaichi sanrin ritou no use case wo sotei˜(in Japanese) (Demonstration experiment of radio wave propagation measurement in 39 GHz band toward establishment of communication area from the sky˜Assuming use cases in urban area, forest, and remote island by HAPS˜”, Press Release, NTT DOCOMO, INC., Mar. 10, 2021
Non Patent Literature 3: “Seisouken wo renzoku muchakuriku hikou, “Sora tobu kichikokyu” ga jitugen he (in Japanese) (Continuous non-landing flight in stratosphere, “base station in flight” to be achieved”), Nikkei Xtec, Mar. 19, 2020, [searched on Dec. 17, 2021], the Internet (URL: https://xtech.nikkei.com/atcl/nxt/mag/ne/18/00007/00100/)
Non Patent Literature 4: Yuki Hokazono, Yoshihisa Kishiyama, and Takahiro Asai, “5G evolution & 6G ni muketa NTN gijutu no kenkyu (in Japanese) (Study of NTN technology for 5G evolution & 6G)”, NTT Technical Journal, pp. 22-27, September 2021

### SUMMARY OF INVENTION

### Technical Problem

By the way, as described above, in particular, when the shielding object is a mobile object such as a vehicle, for example, there are cases where the shielding object exists at a position that blocks the line of sight between the base station and the terminal station and cases where the shielding object does not exist depending on time. In this case, the influence of the shielding object on the communication quality changes with time. Further, in a case where the shielding object is, for example, a tree, there are cases where the leaf is in a thick state and cases where the leaf is in a fallen state depending on the season or the weather. In this case, the influence of the shielding object on the communication quality changes with the time and the weather. Further, the influence on the communication quality may vary depending on the position and distribution of the shielding object in the space of the Fresnel zone, or the like.

Therefore, for example, as in the conventional line-of-sight determination using the three-dimensional point cloud data described above, there is a possibility that the base station to which the terminal station is to be connected for communication is not appropriately selected by simply counting the number of pieces of point cloud data present between the base station and the terminal station at a specific point of time and performing the line-of-sight determination.

In view of the above circumstances, an object of the present invention is to provide a technology that can appropriately select a base station to which the terminal station is to be connected for communication.

### Solution to Problem

An aspect of the present invention is a radio station selection method including an acquisition step of acquiring image information indicating an image obtained by capturing a space through which a radio wave is able to propagate in communication between a first radio station and a second radio station, an estimation step of estimating a propagation loss of a radio wave in the communication on the basis of the image information acquired in the acquisition step, and a determination step of determining whether or not to switch a radio station to which the first radio station is connected for communication from the second radio station to a third radio station on the basis of the propagation loss estimated in the estimation step.

Further, an aspect of the present invention is a radio station selection system including an acquisition unit that acquires image information indicating an image obtained by capturing a space through which a radio wave is able to propagate in communication between a first radio station and a second radio station, an estimation unit that estimates a propagation loss of a radio wave in the communication on the basis of the image information acquired by the acquisition unit, and a determination unit that determines whether or not to switch a radio station to which the first radio station is connected for communication from the second radio station to a third radio station on the basis of the propagation loss estimated by the estimation unit.

### Advantageous Effects of Invention

According to the present invention, it is possible to appropriately select a base station to which a terminal station is to be connected for communication.

### BRIEF DESCRIPTION OF DRAWINGS

FIG. 1 is a diagram illustrating a state of determination of communication availability in consideration of a Fresnel zone fz.

FIG. 2 is a schematic diagram illustrating a state in which line-of-sight determination is performed regarding a Fresnel zone as a cylindrical shape.

FIG. 3 is a diagram in which a cylindrical Fresnel zone Cz is superimposed on a Fresnel zone fz.

FIG. 4 is a schematic diagram illustrating an example of a communication environment in a case where a terminal station is a smartphone.

FIG. 5 is a schematic diagram illustrating an overall configuration of a base station selection system 1 according to a first embodiment of the present invention.

FIG. 6 is a diagram illustrating an example of an image captured by a measurement camera 15 of the base station selection system 1 according to the first embodiment of the present invention.

FIG. 7 is a block diagram illustrating a functional configuration of the base station selection system 1 according to the first embodiment of the present invention.

FIG. 8 is a flowchart illustrating an operation of a base station selection unit 100 according to the first embodiment of the present invention.

FIG. 9 is a diagram illustrating an example of a communication environment in a case where a shielding object is a mobile object.

FIG. 10 is a diagram illustrating a bias of leaves rf in a cross-section of a cylindrical Fresnel zone Cz.

FIG. 11 is a diagram illustrating a bias of leaves rf in the cross-section of the cylindrical Fresnel zone Cz.

FIG. 12 is a block diagram illustrating a functional configuration of a base station selection system 1a according to a modification example of the first embodiment of the present invention.

FIG. 13 is a flowchart illustrating an operation of a learning device 30 according to the modification example of the first embodiment of the present invention.

FIG. 14 is a flowchart illustrating an operation of a terminal station 10a according to the modification example of the first embodiment of the present invention.

FIG. 15 is a diagram illustrating a state in which the communication environment illustrated in FIG. 4 is viewed from above.

FIG. 16 is a schematic diagram illustrating an overall configuration of a base station selection system 1c according to a third embodiment of the present invention.

FIG. 17 is a diagram illustrating a bias of leaves rf in a cross-section of the cylindrical Fresnel zone Cz.

FIG. 18 is a diagram illustrating a bias of leaves rf in the cross-section of the cylindrical Fresnel zone Cz.

FIG. 19 is a schematic diagram illustrating an overall configuration of the base station selection system 1c according to the third embodiment of the present invention.

### DESCRIPTION OF EMBODIMENTS

Hereinafter, a radio station selection method and a radio station selection system according to an embodiment will be described with reference to the drawings.

An actual electromagnetic wave propagates not only in a linear path connecting two radio stations facing each other but also in a path in a space of a spheroid called a Fresnel zone. Accordingly, in order to perform line-of-sight determination between a base station and a terminal station with higher accuracy, it is necessary to perform the line-of-sight determination not only on the straight line connecting the base station and the terminal station but also in consideration of the influence of a shielding object existing within the range of the Fresnel zone.

Note that the Fresnel zone radius of the Fresnel zone in a millimeter wave band is, for example, about 25 [cm] at the maximum in a case where transmission is performed for a distance of 50 [m] using an electromagnetic wave in a 60 [GHz] band. Even in a case where there is no line of sight on a straight line connecting the base station and the terminal station, the line-of-sight determination can be performed more accurately by determining the presence or absence of a line of sight in further consideration of the shielding rate of the Fresnel zone.

Note that the shielding object here is an object that may shield propagation of a radio wave transmitted and received between the base station and the terminal station. The shielding object includes, for example, every object capable of shielding propagation of a radio wave, such as a structure (architecture) such as a dwelling unit and a building, a construction such as a wall of a house and an elevated road, a workpiece such as a road sign and a signboard, a plant such as a street tree and a garden tree, and a raised ground.

In order to make features of the radio station selection method and the radio station selection system according to the embodiment easier to understand, first, an example of a conventional line-of-sight determination method (hereinafter referred to as a “conventional method”) based on three-dimensional point cloud data assuming the Fresnel zone will be described below.

The conventional method performs line-of-sight determination in consideration of the Fresnel zone formed between the base station and the terminal station on the basis of point cloud data. In the conventional method, for example, when the number of pieces of point cloud data included in the range of the Fresnel zone is equal to or less than a predetermined threshold value, it is determined that there is a line of sight (that is, communication is possible between the base station and the terminal station), and when the number is larger than the predetermined threshold value, it is determined that there is no line of sight (that is, communication between the base station and the terminal station is impossible).

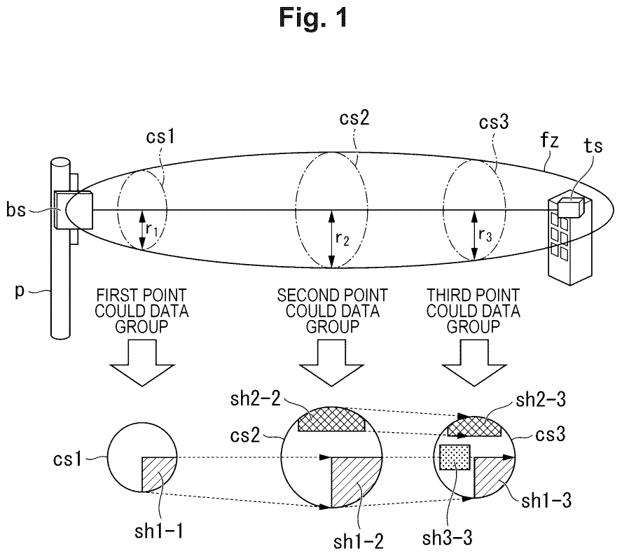

FIG. 1 is a diagram illustrating a state of determination of communication availability in consideration of a Fresnel zone fz. FIG. 1 illustrates a base station bs installed on a utility pole p, and a terminal station ts. Further, FIG. 1 illustrates the Fresnel zone fz formed between the base station bs and the terminal station ts. Furthermore, FIG. 1 illustrates three cross-sections of the Fresnel zone fz (cross-section cs1, cross-section cs2, and cross-section cs3). The cross-section cs1, the cross-section cs2, and the cross-section cs3 are planes orthogonal to a straight line connecting the base station bs and the terminal station ts. In this case, as illustrated in FIG. 1, the shapes of the cross-section cs1, the cross-section cs2, and the cross-section cs3 are circular. The radii of the cross-section cs1, the cross-section cs2, and the cross-section cs3 are r1, r2, and r3, respectively.

In a case where a shielding object exists within the Fresnel zone fz, there is point cloud data in the cross-sections of the Fresnel zone fz. For example, as illustrated in FIG. 1, there is a region sh1-1, which is a region where the point cloud data is present, in the cross-section cs1. Further, there are a region sh1-2 on which the region sh1-1 described above is projected and a region sh2-2, which is a region where the point cloud data is present, in the cross-section cs2. Furthermore, there are a region sh1-3 on which the region sh1-2 described above is further projected, a region sh2-3 on which the region sh2-2 similarly described above is further projected, and a region sh3-3, which is a region where the point cloud data is present, in the cross-section cs3.

In this way, it is possible to recognize a shielding object that can shield propagation of a radio wave, for example, a structure (architecture) such as a dwelling unit and a building, a construction such as a wall of a house and an elevated road, a workpiece such as a road sign and a signboard, a plant such as a street tree and a garden tree, and a raised ground existing in the range of the Fresnel zone fz illustrate in FIG. 1, and the shielding rate in the entire range of the Fresnel zone fz is calculated. Note that the terminal station ts is installed in a structure in FIG. 1, but the same applies even when the terminal station is a mobile terminal.

In the conventional method, for example, the total number of point cloud data included in the plurality of cross-sections of the Fresnel zone fz is counted. That is, in the conventional method, for example, the total number of point cloud data of the cross-section (cross-section cs3 in the drawing) on the most terminal station ts side on which the above projection has been performed is counted. Then, in the conventional method, communication availability between the base station bs and the terminal station ts is determined by comparing the calculated total number of point cloud data with a predetermined threshold value.

Note that, although only three cross-sections are illustrated in FIG. 1, the number of cross-sections used to count the number of pieces of point cloud data may be any number. Note that, as the number of these cross-sections used to calculate the shielding rate increases, more accurate line-of-sight determination can be made, but on the other hand, the calculation load increases.

Note that, alternatively, instead of the number of pieces of point cloud data, a ratio of an area of a region where the point cloud data is present (hereinafter referred to as an “occupancy rate”) to an area of a cross-section of the Fresnel zone may be regarded as the shielding rate, and communication availability between the base station bs and the terminal station ts may be determined. In the conventional method, for example, it may be determined that there is a line of sight (that is, communication is possible between the base station and the terminal station) when the occupancy rate is equal to or less than a predetermined threshold value, and it may be determined that there is no line of sight (that is, communication is not possible between the base station and the terminal station) when the occupancy rate is higher than the predetermined threshold value.

Specifically, in the case of the determination method based on the occupancy rate described above, for example, a plurality of cross-sections of the Fresnel zone fz is superimposed. In this determination method, a ratio indicated by an area corresponding to the region of the point cloud data among the areas of the superimposed cross-sections is calculated as the occupancy rate. Then, in this determination method, communication availability between the base station bs and the terminal station ts is determined by regarding the calculated occupancy rate as the shielding rate and comparing the calculated occupancy rate with a predetermined threshold value.

In other words, even when the number of pieces of point cloud data exceeding the threshold value is present between the base station and the terminal station (that is, even when the shielding object is large or a large number of shielding objects exist), the above-described line-of-sight determination method based on three-dimensional point cloud data in consideration of the shielding rate of the Fresnel zone does not simply determine that there is no line of sight, but performs more detailed line-of-sight determination in consideration of the shielding rate. Thus, this line-of-sight determination method can obtain a more accurate line-of-sight determination result. This is because shielding objects include not only objects that often strongly affect wireless communication like architectures such as buildings, for example, but also objects that relatively weakly affect wireless communication, such as trees with sparsely leafed leaves.

Specifically, in this line-of-sight determination method, for example, the loss amount of the propagation loss of the radio wave is calculated on the basis of the obtained shielding rate. Then, in this line-of-sight determination, presence or absence of a line of sight is determined by designing a line of wireless communication between the base station and the terminal station on the basis of the calculated loss amount. In such calculation of the line-of-sight determination based on the propagation loss of the radio wave, for example, the following Formula (1) can be used.

$${P}_{R} = {P}_{r} + {G}_{T} - L - S + {G}_{R} \geq {P}_{RS} \qquad ( 1 )$$

The meaning of each parameter in the above Formula (1) is as follows.
P_{R}: reception power at terminal station (unit [dBm])
Pᵣ: transmission power at base station (unit [dBm])
G_{T}: maximum transmission antenna gain at base station (unit [dBi])
L: propagation loss amount (unit [dB])
S: loss amount due to shielding rate (unit [dB])
G_{R}: reception antenna gain at terminal station (unit [dBi])
P_{RS}: required reception sensitivity at terminal station (unit [dBm])

This line-of-sight determination method determines that there is a line of sight between the base station and the terminal station when the above Formula (1) is satisfied, that is, when the reception power P_{R} at a terminal station 10 is equal to or more than the required reception sensitivity P_{RS}. On the other hand, this line-of-sight determination method determines that there is no line of sight between the base station and the terminal station when the above Formula (1) is not satisfied, that is, when the reception power P_{R} in the terminal station 10 is lower than the required reception sensitivity P_{RS}.

The value of the above propagation loss amount L can be obtained by the following Formula (2).

$$L = 20 {log}_{10} ( 4 π d / λ ) \qquad ( 2 )$$

The meaning of each parameter in the above Formula (2) is as follows.
d: distance between transmission and reception (unit [m])
λ: wavelength of radio wave used for wireless communication (unit [m])

The value of the above wavelength A can be obtained by the following Formula (3).

$$λ = c / ( f \times {10}^{9} ) \qquad ( 3 )$$

The meaning of each parameter in the above Formula (3) is as follows.
c: speed of light (that is, c=299, 792, 458 [m/s])
f: frequency of radio wave used for wireless communication (unit: [GHz])

The value of the above loss amount S due to the shielding rate above can be obtained by the following Formula (4).

$$S = α \times Sh \qquad ( 4 )$$

The meaning of each parameter in the above Formula (4) is as follows.
Sh: shielding rate (value range: 0.0000 to 1.0000)
α: coefficient (any value can be set by the frequency f and the shielding rate Sh)

As described above, in this line-of-sight determination method, line-of-sight determination can be performed on the basis of whether or not Formula (1) is satisfied by the plurality of parameters described above and the numerical values given by Formulas (2) to (4).

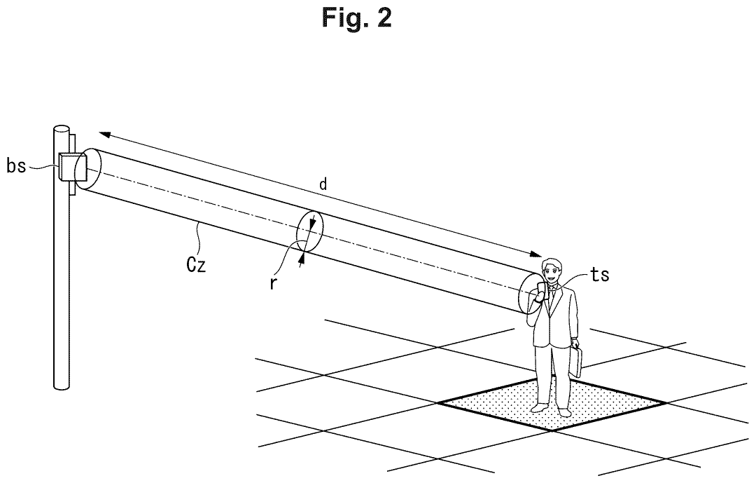

Note that, in order to reduce the amount of calculation related to the line-of-sight determination processing, the line-of-sight determination may be more easily performed by regarding the Fresnel zone, which is a spheroid, as a cylindrical shape, which is a simpler shape. FIG. 2 is a schematic diagram illustrating a state in which line-of-sight determination is performed regarding a Fresnel zone as a cylindrical shape. FIG. 2 illustrates a base station bs, a terminal station ts (corresponding to a representative point), and a Fresnel zone regarded as a cylindrical shape (hereinafter referred to as a “cylindrical Fresnel zone Cz”).

As illustrated in FIG. 2, the length (that is, the distance between the base station bs and the terminal station ts) of the cylindrical Fresnel zone Cz is d, and the radius of the circular cross-section, which is a vertical cross-section of the cylindrical Fresnel zone Cz, is r. Note that the radius r may be a predetermined value, a value of the maximum radius of the circular cross-section of the Fresnel zone fz, which is a spheroid, originally formed between the base station bs and the terminal station ts, or the like.

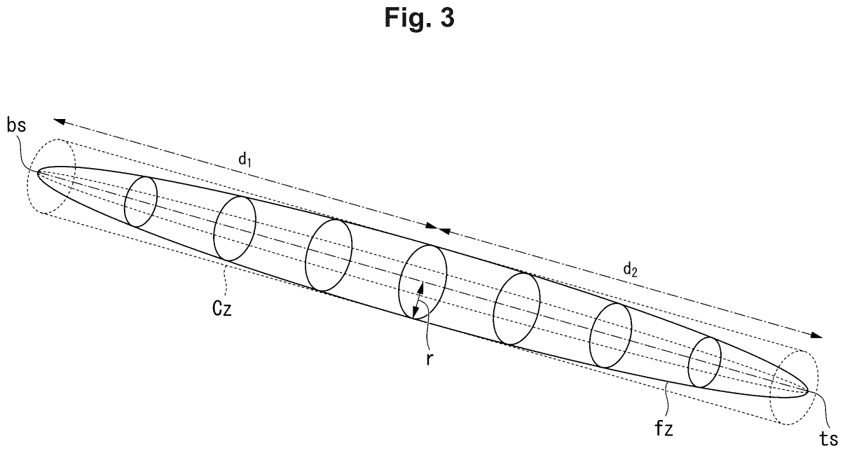

FIG. 3 is a diagram in which the cylindrical Fresnel zone Cz is superimposed on the Fresnel zone fz. When the distance from the base station bs and the distance from the terminal station ts to a certain circular cross-section of the Fresnel zone fz are d₁ and d₂, respectively, it can be expressed as d=d₁+d₂. Further, an n-th Fresnel zone radius r (n) is a function of the wavelength A of a radio wave used for wireless communication, and is expressed by Formula (5) described below.

$$\begin{matrix}[ Math . 1 ] & \\ r ( n ) = \sqrt{\frac{n λ {d}_{1} {d}_{2}}{{d}_{1} + {d}_{2}}} & ( 5 )\end{matrix}$$

Here, the radius r of the cross-section corresponding to the center (d₁=d₂) in a first Fresnel zone, that is, the largest circular cross-section can be expressed by a simpler mathematical expression as in Formula (6) described below.

$$\begin{matrix}[ Math . 2 ] & \\ r = \sqrt{\frac{λ d}{2}} & ( 6 )\end{matrix}$$

Then, the wavelength λ is expressed as a function related to the speed of light c and the frequency f of a radio wave used for wireless communication as in Formula (7) described below. Therefore, it can be said that it makes sense to change the radius of the cylindrical Fresnel zone Cz according to the frequency f such as a millimeter wave band.

$$\begin{matrix}[ Math . 3 ] & \\ λ = \frac{c}{f} & ( 7 )\end{matrix}$$

Note that the user who performs the line-of-sight determination based on the line-of-sight determination method may set the radius r of the circular cross-section in the cylindrical Fresnel zone Cz according to the wavelength λ.

As described above, by regarding the Fresnel zone fz, which is a spheroid, as the cylindrical Fresnel zone Cz as illustrated in FIG. 2, processing of cutting out point cloud data present in the Fresnel zone (that is, it becomes a factor that shields the line of sight) from all the point cloud data present in the evaluation target area is greatly simplified.

Further, as illustrated in FIG. 3, in the Fresnel zone fz which is a spheroid, each of the sizes of circular cross-sections is different depending on the location, and thus the process of superimposing (projecting in order as described above) the shielded portions of the circular cross-sections having different sizes is complicated. On the other hand, by regarding the Fresnel zone fz as the cylindrical Fresnel zone Cz, the above-described complicated process can be replaced with a simple process of just counting the number of pieces of point cloud data present in the cylindrical shape. That is, the line-of-sight determination processing can be made much simpler by using a method of determining whether or not the number of pieces of point cloud data in the cylindrical shape exceeds a threshold value than by using a method of determining whether or not the area of the shielded portion of the superimposed circular cross-sections exceeds a predetermined threshold value.

### First Embodiment

Hereinafter, a first embodiment of the present invention will be described. A base station selection system according to a first embodiment described below is a system that appropriately selects a base station to which a terminal station is to be connected from among a plurality of base stations. The base station selection system selects an appropriate base station in consideration of shielding objects existing within a Fresnel zone formed in wireless communication between the base station and the terminal station.

In the first embodiment, the base station is a radio base station installed in an outdoor facility such as a high-rise building or a utility pole, and the terminal station is, for example, a terminal device installed on a wall surface of a low-rise house in a fixed wireless access (FWA) system, or a movable wireless terminal such as a smartphone or a tablet terminal. For example, unlicensed band millimeter wave radio is used for communication between the base station and the terminal station.

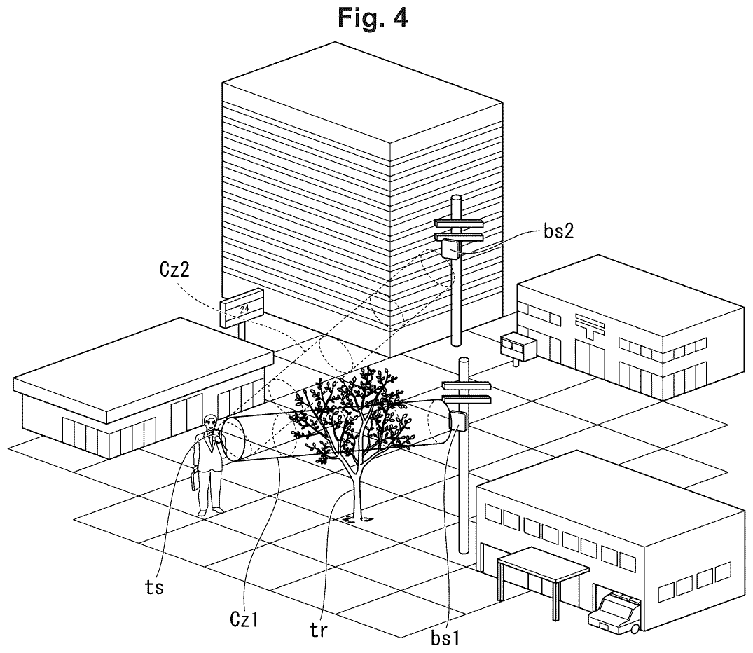

FIG. 4 is a schematic diagram illustrating an example of a communication environment in a case where the terminal station is a smartphone. FIG. 4 illustrates an urban area in which, for example, an office building, a post office, a fire department, a convenience store, and the like are built. Further, a plurality of utility poles to which base stations of the wireless communication system are attached is installed in this urban area. As illustrated in FIG. 4, for example, a base station bs1 is attached to the utility pole installed near the fire department, and a base station bs2 is attached to the utility pole installed near the office building.

Further, FIG. 4 illustrates a user holding a terminal station ts that is a smartphone. Furthermore, FIG. 4 illustrates a cylindrical Fresnel zone Cz1 approximating a Fresnel zone formed between the base station bs1 and the terminal station ts and a cylindrical Fresnel zone Cz2 approximating a Fresnel zone formed between the base station bs2 and the terminal station ts.

As illustrated in FIG. 4, a tree tr is planted between the base station bs1 and the terminal station ts. Then, a part of the tree tr is within the range of the cylindrical Fresnel zone Cz1. Therefore, in a case where the terminal station ts is connected for communication to the base station bs1, there is a possibility that the tree tr influences the quality of wireless communication (that is, degrades the communication quality) performed between the terminal station ts and the base station bs1 to no small extent. On the other hand, no shielding object such as a tree exists within the range of the cylindrical Fresnel zone Cz2.

The base station selection system 1 according to the first embodiment performs control so that the terminal station ts switches the connection destination to another base station (for example, the base station bs2 in FIG. 4) in a case where there is a shielding object such as a tree tr illustrated in FIG. 4, for example, between the base station bs1 and the terminal station ts and the quality of communication between the base station bs1 and the terminal station ts is degraded by the shielding object.

### [Overall Configuration of Base Station Selection System]

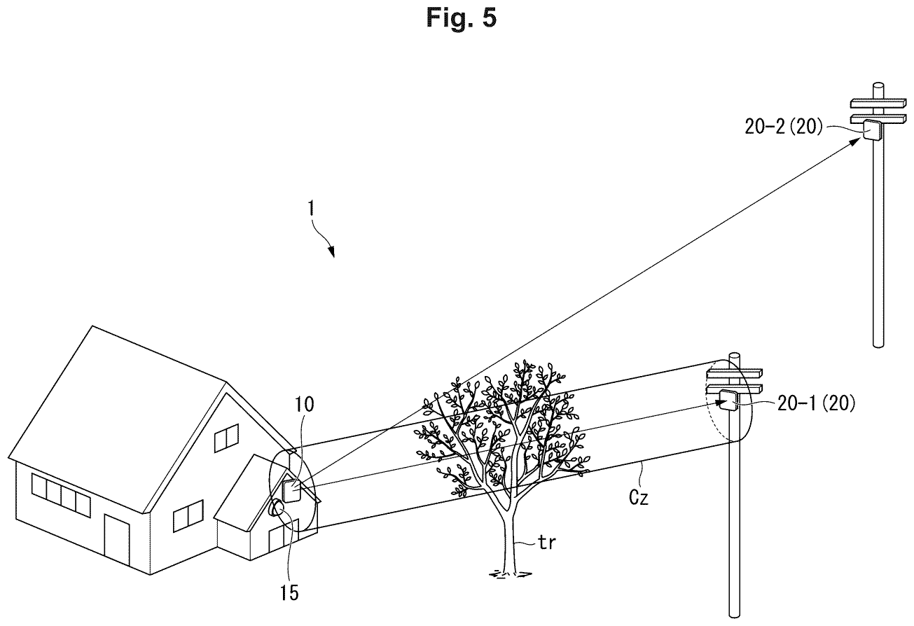

FIG. 5 is a schematic diagram illustrating an overall configuration of a base station selection system 1 according to the first embodiment of the present invention. Further, FIG. 5 illustrates an example of a communication environment in a case where the terminal station is a terminal device installed on a wall surface of a low-rise house. In the following description, such a communication environment will be described as an example.

FIG. 5 illustrates a low-rise house in which the terminal station 10 and a measurement camera 15 are attached to a wall surface, a utility pole to which a base station 20-1 is attached, and a utility pole to which a base station 20-2 is attached. Further, FIG. 5 illustrates a cylindrical Fresnel zone Cz approximating the Fresnel zone formed between the base station 20-1 and the terminal station 10.

As illustrated in FIG. 5, a tree tr is planted between the base station 20-1 and the terminal station 10. Then, a part of the tree tr is within the range of the cylindrical Fresnel zone Cz. Therefore, in a case where the terminal station 10 is connected for communication to the base station 20-1, there is a possibility that the tree tr influences the quality of wireless communication (that is, degrades the communication quality) performed between the terminal station 10 and the base station 20-1 to no small extent.

As illustrated in FIG. 5, the measurement camera 15 is attached near the terminal station 10. The measurement camera 15 captures an image in a direction in which the base station 20-1 exists. Therefore, the image captured by the measurement camera 15 shows a state when the direction in which the base station 20-1 exists is viewed from the position of the terminal station 10. The measurement camera 15 may be configured to be able to further capture an image in a direction in which another base station (for example, the base station 20-2 and the like) exists.

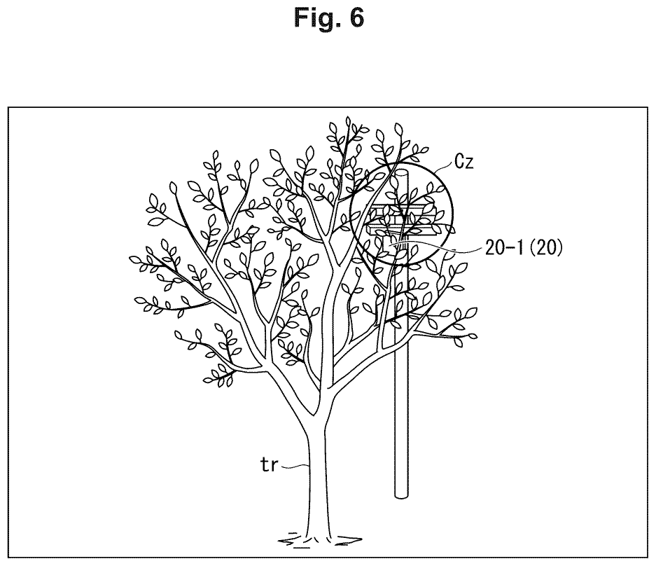

FIG. 6 is a diagram illustrating an example of an image captured by the measurement camera 15 of the base station selection system 1 according to the first embodiment. As illustrated in FIG. 6, the image captured by the measurement camera 15 includes a utility pole to which the base station 20-1 is attached and a tree tr planted between the terminal station 10 and the base station 20-1. Furthermore, as illustrated in FIG. 6, it can be seen that the base station 20-1 is not entirely visible but is partially visible through gaps between leaves of the tree tr when viewed from the position of the measurement camera 15 (that is, the position of the terminal station 10).

In FIG. 6, a range surrounded by a solid circle is a range of the cylindrical Fresnel zone Cz. Therefore, in communication between the terminal station 10 and the base station 20-1, the radio wave propagates in a space within the range of this circle. The base station selection system 1 according to the first embodiment uses an arbitrary image analysis method to specify an image region in which a shielding object (for example, the tree tr or the like) is captured within the range of this circle. Then, for example, the base station selection system 1 calculates, as the shielding rate, the ratio of the area of the image region in which the shielding object is captured in the area of the circle.

Then, the base station selection system 1 calculates the loss amount of the propagation loss of the radio wave using the value of the calculated shielding rate, and performs line-of-sight determination on the basis of whether or not the calculation formula of the above Formula (1) is satisfied. When it is determined that there is no line of sight between the terminal station 10 and the base station 20-1, the base station selection system 1 performs control to switch the connection destination of the terminal station 10 to another base station (for example, the base station 20-2 of FIG. 5).

Note that the base station selection system 1 may also perform line-of-sight determination between the terminal station 10 and another base station (for example, the base station 20-2 of FIG. 5) at the same time, and may control the terminal station 10 to switch the connection destination to a base station having the largest P_{R} (reception power in the terminal station 10) in the above Formula (1), for example.

### [Functional Configuration of Base Station Selection System]

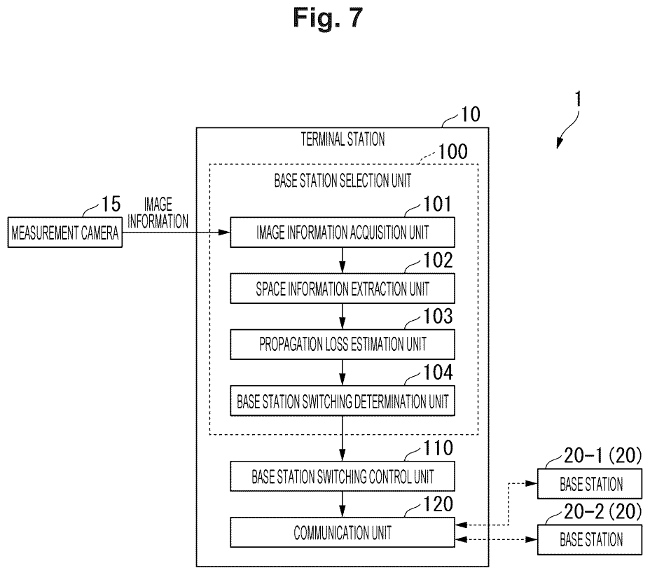

Hereinafter, a functional configuration of the base station selection system 1 will be described. FIG. 7 is a block diagram illustrating the functional configuration of the base station selection system 1 according to the first embodiment of the present invention.

As illustrated in FIG. 7, the base station selection system 1 includes the terminal station 10, the measurement camera 15, and the plurality of base stations 20 (the base station 20-1 and the base station 20-2).

The terminal station 10 is, for example, a terminal device installed on a wall surface of a low-rise house in a fixed wireless access (FWA) system. Note that the terminal station 10 may be a mobile wireless terminal such as a smartphone and a tablet terminal, or the like. The terminal station 10 is connected for communication to the base stations 20 and transmits and receives information to and from each other. The terminal station 10 appropriately selects an appropriate base station 20 as a connection destination from among a plurality of connectable base stations 20. The terminal station 10 switches the connection destination to be connected for communication to the selected base station 20.

The measurement camera 15 is, for example, an optical camera installed near the terminal station 10. Since the measurement camera 15 is a camera intended to capture an image of the direction of the base station 20 viewed from the position of the terminal station 10, it is desirable that the measurement camera is installed at substantially the same position as the terminal station 10. Note that the measurement camera 15 may be built in the terminal station 10. The measurement camera 15 captures an image of the direction in which the base station 20 exists, for example, periodically (for example, every minute). The measurement camera 15 transmits image information indicating an image obtained by image-capturing to the terminal station 10.

The base station 20 is a radio base station installed at a distance capable of communicating with the terminal station 10. The base station 20 is installed in an outdoor facility such as a utility pole or a high-rise building, for example. The base station 20 is connected for communication to the terminal station 10 and transmits and receives information to and from each other.

Hereinafter, a functional configuration of the terminal station 10 will be described in more detail. As illustrated in FIG. 7, the terminal station 10 includes a base station selection unit 100, a base station switching control unit 110, and a communication unit 120.

The base station selection unit 100 determines whether or not it is necessary to switch the base station 20 to be a connection destination on the basis of the image information acquired from the measurement camera 15, and outputs information indicating the base station 20 newly selected as a connection destination to the base station switching control unit 110 when it is determined that it is necessary to switch the base station 20.

The base station switching control unit 110 acquires the information indicating the base station 20 selected as a new connection destination output from the base station selection unit 100. The base station switching control unit 110 controls the communication unit 120 to switch the base station 20 to be the connection destination on the basis of the acquired information.

The communication unit 120 is connected for communication to the base station 20 and transmits and receives information to and from the base station 20. The communication unit 120 switches the connection destination base station 20 under the control of the base station switching control unit 110.

Hereinafter, a functional configuration of the base station selection unit 100 will be described in more detail. As illustrated in FIG. 7, the base station selection unit 100 includes an image information acquisition unit 101, a space information extraction unit 102, a propagation loss estimation unit 103, and a base station switching determination unit 104. Note that, in the first embodiment, the base station selection unit 100 is built in the terminal station 10, but it is not limited to this configuration, and the base station selection unit 100 may be provided in an external device separately from the terminal station 10.

The image information acquisition unit 101 acquires the image information transmitted from the measurement camera 15. The image information mentioned here is information indicating an image obtained by capturing a direction in which the base station 20 exists from the position of the measurement camera 15 (that is, substantially the same position as the terminal station 10). The image information acquisition unit 101 outputs the acquired image information to the space information extraction unit 102.

The space information extraction unit 102 acquires the image information output from the image information acquisition unit 101. The space information extraction unit 102 performs an image analysis on an image based on the acquired image information. The image analysis mentioned here is an analysis for specifying the position of the base station 20 in the image and the state of a space in the range of the cylindrical Fresnel zone Cz from the image. Specifically, the space information extraction unit 102 specifies the position of the base station 20 in the image, the range of the cylindrical Fresnel zone Cz, a shielded region within the range of the cylindrical Fresnel zone Cz, and the like. Note that any conventional method may be used as the image analysis method. The space information extraction unit 102 outputs, to the propagation loss estimation unit 103, information indicating the state of the space (hereinafter referred to as “space information”) within the range of the cylindrical Fresnel zone Cz specified by the image analysis.

The propagation loss estimation unit 103 acquires the space information output from the space information extraction unit 102. The propagation loss estimation unit 103 calculates a shielding rate within the range of the cylindrical Fresnel zone Cz specified by the space information extraction unit 102 on the basis of the acquired space information. The propagation loss estimation unit 103 estimates a loss amount of a propagation loss due to the shielding rate on the basis of the calculated shielding rate. Specifically, the propagation loss estimation unit 103 estimates the loss amount of the propagation loss due to the shielding rate on the basis of the calculated shielding rate and the above Formula (4), for example. The propagation loss estimation unit 103 outputs information indicating the estimated loss amount of the propagation loss due to the shielding rate to the base station switching determination unit 104.

The base station switching determination unit 104 acquires the information indicating the loss amount of the propagation loss due to the shielding rate output from the propagation loss estimation unit 103. The base station switching determination unit 104 determines whether or not the above Formula (1) is satisfied using the loss amount based on the acquired information. That is, the base station switching determination unit 104 calculates the reception power P_{R} in the terminal station 10 on the basis of the acquired loss amount S of the propagation loss due to the shielding rate, and the like. Then, the base station switching determination unit 104 compares the calculated value of the reception power P_{R} in the terminal station 10 with a predetermined value of the required reception sensitivity P_{RS} in the terminal station 10, and determines that it is not necessary to switch the base station 20 to be the connection destination when the value of the reception power P_{R} is equal to or larger than the value of the required reception sensitivity P_{RS}.

On the other hand, when the value of the reception power P_{R} is less than the value of the required reception sensitivity P_{RS}, the base station switching determination unit 104 determines that it is necessary to switch the base station 20 to be the connection destination. In this case, the base station switching determination unit 104 outputs information indicating the base station 20 to be newly switched as the connection destination to the base station switching control unit 110.

Note that the base station selection unit 100 may further perform processing similar to the above for the other base stations 20 (for example, the base station 20-2 in this case assuming that the terminal station 10 is currently connected for communication to the base station 20-1), and determine whether or not it is necessary to switch the base station 20 to be the connection destination on the basis of the calculated value of the reception power P_{R}.

Note that, for example, the base station selection unit 100 may be configured to perform processing similar to the above for all the base stations 20 to which the terminal station 10 can be connected for communication and calculate respective values of the reception power P_{R}, and switch the base stations 20 such that the base station 20 having the largest value of the reception power P_{R} is set as a new connection destination.

Note that, for example, the space information extraction unit 102, the propagation loss estimation unit 103, and the base station switching determination unit 104 may be configured as components of one control unit (not illustrated). In this case, the control unit is implemented by, for example, a hardware processor such as a central processing unit (CPU) executing a program (software). Alternatively, the control unit may be configured to be implemented by cooperation of software and hardware. The program read by the CPU may be stored in advance in, for example, a storage medium (not illustrated) included in the base station selection system 1. Furthermore, not only the space information extraction unit 102, the propagation loss estimation unit 103, and the base station switching determination unit 104 but also the base station switching control unit 110 may be configured as a component of one control unit (not illustrated).

### [Operation of Terminal Station]

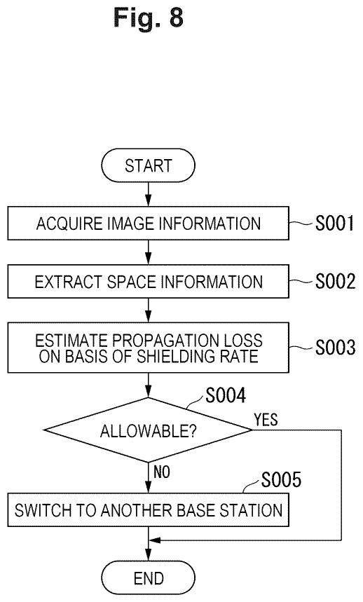

Hereinafter, the operation of the terminal station 10 according to the first embodiment will be described. FIG. 8 is a flowchart illustrating the operation of the base station selection unit 100 according to the first embodiment of the present invention. The operation of the terminal station 10 illustrated in the flowchart of FIG. 8 is started, for example, periodically (for example, every minute).

First, the image information acquisition unit 101 acquires the image information transmitted from the measurement camera 15 (step S001). The image information acquisition unit 101 outputs the acquired image information to the space information extraction unit 102.

Next, the space information extraction unit 102 acquires the image information output from the image information acquisition unit 101. The space information extraction unit 102 performs an image analysis on an image based on the acquired image information, and extracts space information such as the position of the base station 20, the range of the cylindrical Fresnel zone Cz, and a shielded region within the range of the cylindrical Fresnel zone Cz in the image (step S002). The space information extraction unit 102 outputs the extracted space information to the propagation loss estimation unit 103.

The propagation loss estimation unit 103 acquires the space information output from the space information extraction unit 102. The propagation loss estimation unit 103 calculates a shielding rate within the range of the cylindrical Fresnel zone Cz specified by the space information extraction unit 102 on the basis of the acquired space information. The propagation loss estimation unit 103 estimates the loss amount of the propagation loss due to the shielding rate on the basis of the calculated shielding rate (step S003). The propagation loss estimation unit 103 outputs information indicating the estimated loss amount of the propagation loss due to the shielding rate to the base station switching determination unit 104.

The base station switching determination unit 104 acquires the information indicating the loss amount of the propagation loss due to the shielding rate output from the propagation loss estimation unit 103. The base station switching determination unit 104 calculates reception power in the terminal station 10 on the basis of the loss amount based on the acquired information. Then, the base station switching determination unit 104 determines whether or not the calculated value of the reception power is an allowable value (step S004).

When the calculated value of the reception power is an allowable value (step S004: YES), the base station switching determination unit 104 determines that it is not necessary to switch the connection destination to another base station 20. Thus, the operation of the terminal station 10 illustrated in the flowchart of FIG. 8 ends.

On the other hand, when the calculated value of the reception power is not an allowable value (step S004: NO), the base station switching determination unit 104 determines that it is necessary to switch the base station 20 to be the connection destination. In this case, the base station switching determination unit 104 outputs information indicating the base station 20 newly selected as the connection destination to the base station switching control unit 110.

The base station switching control unit 110 acquires the information indicating the base station 20 selected as a new connection destination output from the base station selection unit 100. The base station switching control unit 110 controls the communication unit 120 to switch the base station 20 to be the connection destination on the basis of the acquired information (step S005). Thus, the operation of the terminal station 10 illustrated in the flowchart of FIG. 8 ends.

As described above, the base station selection system 1 according to the first embodiment of the present invention appropriately acquires image information indicating an image in which the direction of the base station 20 is captured by the measurement camera 15 installed at substantially the same position as the terminal station 10. The base station selection system 1 specifies the position of the base station 20 and an image region of a shielding object existing within the range of the cylindrical Fresnel zone Cz from the acquired image. The base station selection system 1 calculates the shielding rate of the cylindrical Fresnel zone Cz from the image region of the specified shielding object, and estimates the propagation loss of the radio wave in the communication between the terminal station 10 and the base station 20 on the basis of the calculated shielding rate. The base station selection system 1 determines whether or not it is necessary to switch the base station 20 to which the terminal station 10 is connected to another base station 20 on the basis of the estimated propagation loss.

With such a configuration, the base station selection system 1 according to the first embodiment of the present invention can perform, for example, the line-of-sight determination by using the space information indicating a more immediate situation within the range of the cylindrical Fresnel zone Cz, unlike the conventional line-of-sight determination method in which the number of pieces of point cloud data present between the base station and the terminal station at a certain time point is simply counted. Thus, the base station selection system 1 can more appropriately select the base station 20 to which the terminal station 10 is connected for communication even in a case where the influence of the shielding object on the communication quality changes with time, for example, in a case where the shielding object is a mobile object such as a vehicle.

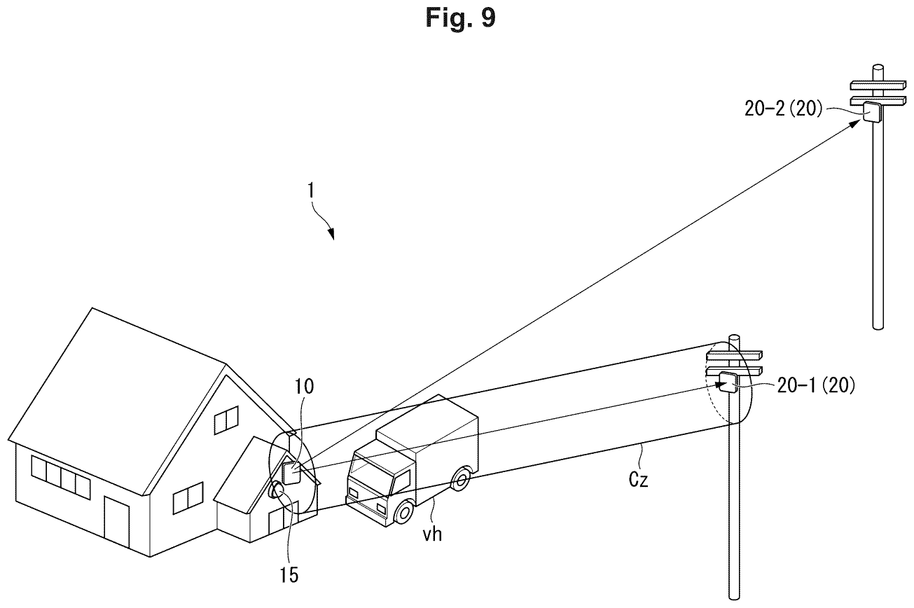

FIG. 9 is a diagram illustrating an example of a communication environment in a case where the shielding object is a mobile object (large vehicle). FIG. 9 illustrates a low-rise house in which the terminal station 10 and the measurement camera 15 are attached to a wall surface, a utility pole to which the base station 20-1 is attached, and a utility pole to which the base station 20-2 is attached. Further, FIG. 9 illustrates a cylindrical Fresnel zone Cz approximating the Fresnel zone formed between the base station 20-1 and the terminal station 10.

As illustrated in FIG. 9, a large vehicle vh exists between the base station 20-1 and the terminal station 10. Then, a part of the large vehicle vh is within the range of cylindrical Fresnel zone Cz. Therefore, in a case where the terminal station 10 is connected for communication to the base station 20-1, there is a possibility that the large vehicle vh influences the quality of the wireless communication (that is, degrades the communication quality) performed between the terminal station 10 and the base station 20-1 to no small extent.

However, since the large vehicle vh is a mobile object, the large vehicle vh may not exist between the base station 20-1 and the terminal station 10 depending on the time zone as the large vehicle vh moves. Further, the magnitude of the influence (that is, to what extent the communication quality is degraded) of the large vehicle vh on the quality of wireless communication performed between the terminal station 10 and the base station 20-1 varies depending on the position of the large vehicle vh. However, even in such a case where the shielding object is a mobile object and the communication environment constantly changes in this manner, the base station selection system 1 according to the first embodiment of the present invention can use the space information indicating a more immediate situation within the range of the cylindrical Fresnel zone Cz, and thus can more appropriately select the base station 20 to which the terminal station 10 is to be connected for communication.

Note that, although not illustrated, the terminal station 10 may be a mobile object such as a smartphone, for example. In this case, the measurement camera 15 is provided in, for example, the terminal station 10 (smartphone or the like). In this case, even if the terminal station 10 moves, a mechanism is required by which the measurement camera 15 can capture an image in the direction of the base station 20-1 as necessary. Furthermore, both the terminal station 10 and the shielding object may be mobile objects. Even in such a case, the base station selection system 1 according to the first embodiment of the present invention can use space information indicating a more immediate situation within the range of the cylindrical Fresnel zone Cz, and thus can more appropriately select the base station 20 to which the terminal station 10 is connected for communication.

Further, with the above configuration, the base station selection system 1 according to the first embodiment of the present invention can perform, for example, the line-of-sight determination in consideration of the presence of the shielding object in the entire space within the range of the cylindrical Fresnel zone Cz, unlike the conventional line-of-sight determination method using the point cloud data of only some cross-sections of the Fresnel zone. Thus, the base station selection system 1 can more appropriately select the base station 20 to which the terminal station 10 is connected for communication even in a case where the influence of the shielding object on the communication quality changes depending on the season or the weather, for example, as in a case where the covering object is a tree.

### Modification Example of First Embodiment

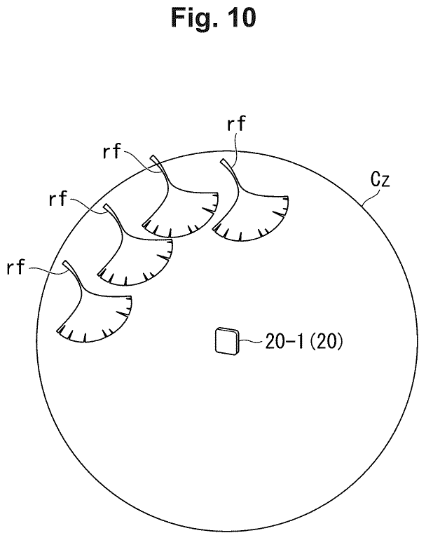

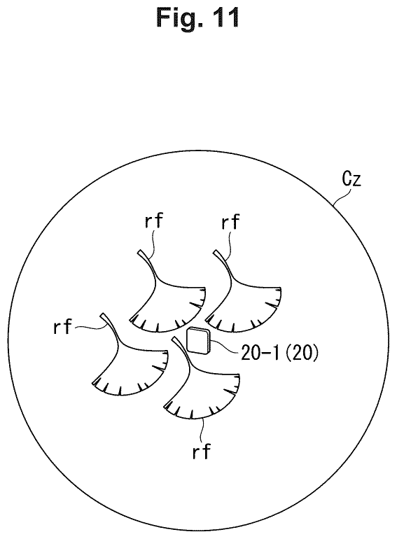

In the first embodiment described above, FIG. 6 illustrates an example of a case where leaves of the tree tr are sparsely present on the entire cross-section of the cylindrical Fresnel zone Cz viewed from the terminal station 10 side. However, as illustrated in FIGS. 10 and 11, for example, leaves rf may be biased to a part of the cross-section of the cylindrical Fresnel zone Cz.

In the cross-section of the cylindrical Fresnel zone Cz illustrated in FIG. 10, leaves rf are present biased to the upper left. On the other hand, in the cross-section of the cylindrical Fresnel zone Cz illustrated in FIG. 11, leaves rf are present biased to the center. In this case, in both cases of FIGS. 10 and 11, the shielding rates have equivalent values. However, in the case of FIG. 10, the entire base station 20-1 can be directly viewed from the position of the terminal station 10, but in the case of FIG. 11, only a part of the base station 20 can be directly viewed from the position of the terminal station 10 because it is in the shadow of the leaves rf. In such a case, even if the shielding rates are equivalent values, a large difference may occur in the value of the propagation loss based on the shielding rate. Specifically, the value of the propagation loss is expected to be larger in the case of FIG. 11.

A base station selection system 1a according to a modification example of the first embodiment described below does not calculate a shielding rate on the basis of space information and estimate a propagation loss as in the base station selection system 1 according to the first embodiment described above, but estimates the propagation loss from the space information using a learned model by machine learning. Thus, the base station selection system 1a according to the modification example of the first embodiment can estimate a more accurate propagation loss even if the shielding rates are equivalent values.

### [Functional Configuration of Base Station Selection System]

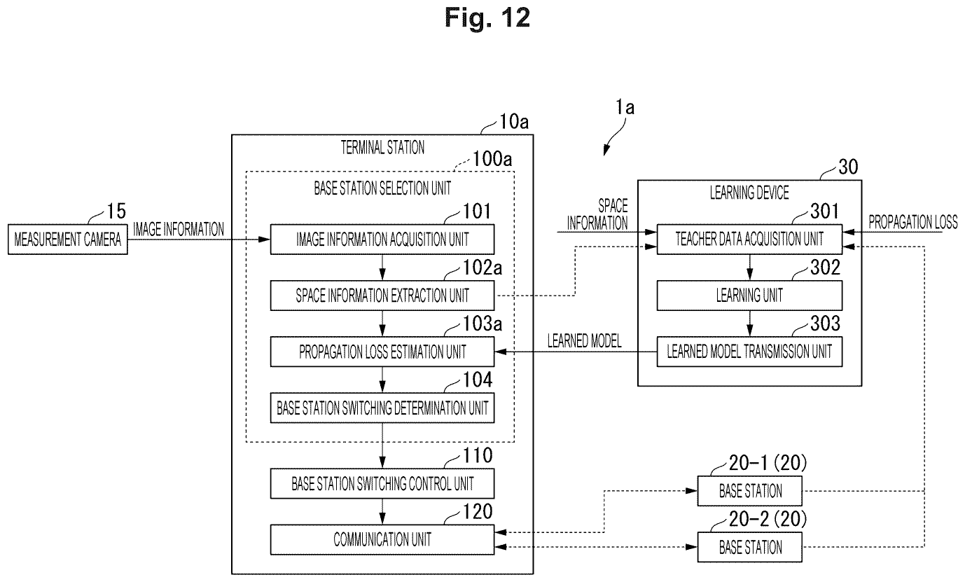

Hereinafter, a functional configuration of the base station selection system 1a will be described. FIG. 12 is a block diagram illustrating the functional configuration of the base station selection system 1a according to the modification example of the first embodiment of the present invention.

As illustrated in FIG. 12, the base station selection system 1a includes a terminal station 10a, the measurement camera 15, the plurality of base stations 20 (the base station 20-1 and the base station 20-2), and a learning device 30.

The terminal station 10a is, for example, a terminal device installed on a wall surface of a low-rise house in the FWA system. Note that the terminal station 10a may be a mobile wireless terminal such as a smartphone and a tablet terminal, or the like. The terminal station 10a is connected for communication to the base station 20 and transmits and receives information to and from each other. The terminal station 10a appropriately selects an appropriate base station 20 as a connection destination from among a plurality of connectable base stations 20. The terminal station 10a switches the connection destination to be connected for communication to the selected base station 20.

The measurement camera 15 is, for example, an optical camera installed near the terminal station 10a. Since the measurement camera 15 is a camera intended to capture an image of the direction of the base station 20 viewed from the position of the terminal station 10a, it is desirable that the measurement camera is installed at substantially the same position as the terminal station 10a. Note that the measurement camera 15 may be built in the terminal station 10a. The measurement camera 15 captures an image of the direction in which the base station 20 exists, for example, periodically (for example, every minute). The measurement camera 15 transmits image information indicating an image obtained by image-capturing to the terminal station 10a.

The base station 20 is a radio base station installed at a distance communicable with the terminal station 10a. The base station 20 is installed in an outdoor facility such as a utility pole or a high-rise building, for example. The base station 20 is connected for communication to the terminal station 10a and transmits and receives information to and from each other.

Note that the base station 20 may output information indicating a propagation loss of a radio wave actually generated in communication with the terminal station 10a to the learning device 30 to be described later. In this case, the information indicating the propagation loss is used as a piece of teacher data of machine learning performed by the learning device 30, for example.

Hereinafter, a functional configuration of the terminal station 10a will be described in more detail. As illustrated in FIG. 12, the terminal station 10a includes a base station selection unit 100a, the base station switching control unit 110, and the communication unit 120.

The base station selection unit 100a determines whether or not it is necessary to switch the base station 20 to be a connection destination on the basis of the image information acquired from the measurement camera 15, and outputs information indicating the base station 20 newly selected as a connection destination to the base station switching control unit 110 when it is determined that it is necessary to switch the base station 20. Note that the configurations of the base station switching control unit 110 and the communication unit 120 are similar to those of the first embodiment described above, and thus description thereof is omitted.

Hereinafter, a functional configuration of the base station selection unit 100a will be described in more detail. As illustrated in FIG. 12, the base station selection unit 100a includes an image information acquisition unit 101, a space information extraction unit 102a, a propagation loss estimation unit 103a, and a base station switching determination unit 104. Note that, in the modification example of the first embodiment, the base station selection unit 100a is built in the terminal station 10a, but it is not limited to this configuration, and the base station selection unit 100a may be provided in an external device separately from the terminal station 10a.

The image information acquisition unit 101 acquires the image information transmitted from the measurement camera 15. The image information mentioned here is information indicating an image obtained by capturing a direction in which the base station 20 exists from the position of the measurement camera 15 (that is, substantially the same position as the terminal station 10). The image information acquisition unit 101 outputs the acquired image information to the space information extraction unit 102a.

The space information extraction unit 102a acquires the image information output from the image information acquisition unit 101. The space information extraction unit 102a performs an image analysis on an image based on the acquired image information. The image analysis mentioned here is an analysis for specifying the position of the base station 20 in the image and the state of a space in the range of the cylindrical Fresnel zone Cz from the image. Specifically, the space information extraction unit 102a specifies the position of the base station 20 in the image, the range of the cylindrical Fresnel zone Cz, and the like. Note that any conventional method may be used as the image analysis method. The space information extraction unit 102a outputs, to the propagation loss estimation unit 103, information including information indicating the state of the space within the range of the cylindrical Fresnel zone Cz specified by the image analysis and the image information as space information.

Note that, as illustrated in FIG. 12, the space information extraction unit 102a may output the space information to the learning device 30 to be described later. In this case, the space information is used as one of teacher data of machine learning performed by the learning device 30, for example.

The propagation loss estimation unit 103a acquires the space information output from the space information extraction unit 102a. Further, the propagation loss estimation unit 103a acquires a learning model (hereinafter referred to as a “learned model”) learned by machine learning and transmitted from the learning device 30 to be described later. The learned model receives the space information as an input and outputs an estimated value of the loss amount of the propagation loss due to the shielding rate. The propagation loss estimation unit 103a obtains the estimated value of the loss amount of the propagation loss due to the shielding rate by inputting the space information acquired from the space information extraction unit 102a to the learned model. The propagation loss estimation unit 103a outputs information indicating the estimated loss amount of the propagation loss due to the shielding rate to the base station switching determination unit 104.

The base station switching determination unit 104 acquires the information indicating the loss amount of the propagation loss due to the shielding rate output from the propagation loss estimation unit 103a. The base station switching determination unit 104 determines whether or not the above Formula (1) is satisfied using the loss amount based on the acquired information. That is, the base station switching determination unit 104 calculates the reception power P_{R} in the terminal station 10a on the basis of the acquired loss amount S of the propagation loss due to the shielding rate, and the like. Then, the base station switching determination unit 104 compares the calculated value of the reception power P_{R} in the terminal station 10a with a predetermined value of the required reception sensitivity P_{RS} in the terminal station 10a, and determines that it is not necessary to switch the base station 20 to be the connection destination when the value of the reception power P_{R} is equal to or larger than the value of the required reception sensitivity P_{RS}.

On the other hand, when the value of the reception power P_{R} is less than the value of the required reception sensitivity P_{RS}, the base station switching determination unit 104 determines that it is necessary to switch the base station 20 to be the connection destination. In this case, the base station switching determination unit 104 outputs information indicating the base station 20 to be newly switched as the connection destination to the base station switching control unit 110.

Note that the base station selection unit 100a may further perform processing similar to the above for the other base stations 20 (for example, the base station 20-2 in this case assuming that the terminal station 10a is currently connected for communication to the base station 20-1), and determine whether or not it is necessary to switch the base station 20 to be the connection destination on the basis of the calculated value of the reception power P_{R}.

Note that, for example, the base station selection unit 100a may be configured to perform processing similar to the above for all the base stations 20 to which the terminal station 10a can be connected for communication and calculate respective values of the reception power P_{R}, and switch the base stations 20 such that the base station 20 having the largest value of the reception power P_{R} is set as a new connection destination.

Note that, for example, the space information extraction unit 102a, the propagation loss estimation unit 103a, and the base station switching determination unit 104 may be configured as components of one control unit (not illustrated). In this case, the control unit is implemented by, for example, a hardware processor such as a CPU executing a program (software). Alternatively, the control unit may be configured to be implemented by cooperation of software and hardware. The program read by the CPU may be stored in advance in, for example, a storage medium (not illustrated) included in the base station selection system 1a. Furthermore, not only the space information extraction unit 102a, the propagation loss estimation unit 103a, and the base station switching determination unit 104 but also the base station switching control unit 110 may be configured as a component of one control unit (not illustrated).

The learning device 30 is, for example, an information processing device such as a general-purpose computer. The learning device 30 includes a teacher data acquisition unit 301, a learning unit 302, and a learned model transmission unit 303. Note that the learning device 30 may be built in the terminal station 10a.

The teacher data acquisition unit 301 acquires a large amount of teacher data from an external device. The teacher data mentioned here is information in which space information indicating a situation of a space within the range of the cylindrical Fresnel zone Cz actually generated and information indicating a propagation loss of a radio wave actually generated in communication between the terminal station 10a and the base station 20 in the situation form one set. The teacher data acquisition unit 301 outputs the teacher data to the learning unit 302.

Note that the teacher data acquisition unit 301 may further use, as the teacher data, information in which the actual space information output from the space information extraction unit 102a and the information indicating the actual propagation loss output from the base station 20 form one set.

The learning unit 302 acquires the teacher data output from the teacher data acquisition unit 301. The learning unit 302 performs machine learning using the space information included in the teacher data and the information indicating the propagation loss as inputs. Note that, as described above, in the modification example of the first embodiment, the space information includes, for example, space information including information such as the position of the base station 20 and the range of the cylindrical Fresnel zone Cz, and image information. The learning unit 302 outputs the learned model generated by performing machine learning to the learned model transmission unit 303.

The learned model transmission unit 303 acquires the learned model output from the learning unit 302. The learned model transmission unit 303 transmits the acquired learned model to the propagation loss estimation unit 103a.

### [Operation of Learning Device]

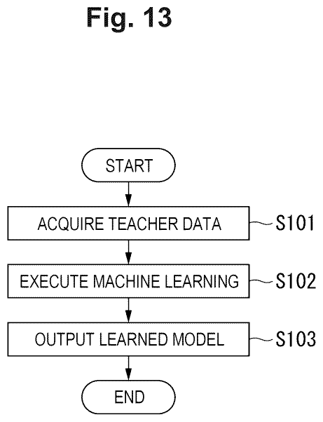

Hereinafter, the operation of the learning device 30 according to the modification example of the first embodiment will be described. FIG. 13 is a flowchart illustrating the operation of the learning device 30 according to the modification example of the first embodiment of the present invention.

First, the teacher data acquisition unit 301 acquires a large amount of teacher data from an external device (step S101). The teacher data acquisition unit 301 outputs the teacher data to the learning unit 302.

Next, the learning unit 302 acquires the teacher data output from the teacher data acquisition unit 301. The learning unit 302 performs machine learning using the space information included in the teacher data and the information indicating the propagation loss as inputs (step S102). The learning unit 302 outputs the learned model generated by performing machine learning to the learned model transmission unit 303.

Next, the learned model transmission unit 303 acquires the learned model output from the learning unit 302. The learned model transmission unit 303 transmits the acquired learned model to the propagation loss estimation unit 103a (step S103). Thus, the operation of the learning device 30 illustrated in the flowchart of FIG. 13 ends.

### [Operation of Terminal Station]

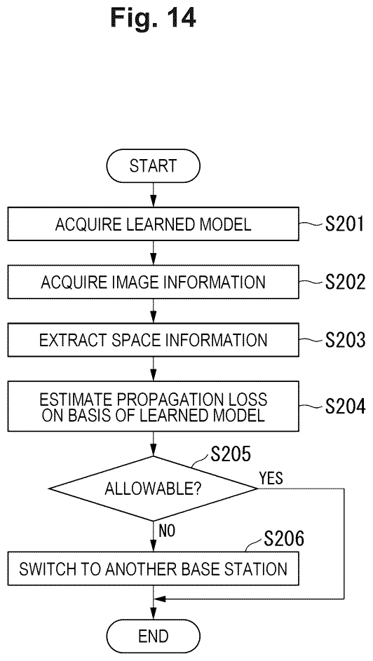

Hereinafter, the operation of the terminal station 10a according to the modification example of the first embodiment will be described. FIG. 14 is a flowchart illustrating the operation of the terminal station 10a according to the modification example of the first embodiment of the present invention. The operation of the terminal station 10 illustrated in the flowchart of FIG. 14 is started, for example, periodically (for example, every minute).

First, the propagation loss estimation unit 103a acquires the learned model transmitted from the learning device 30 (step S201).

Next, the image information acquisition unit 101 acquires the image information transmitted from the measurement camera 15 (step S202). The image information acquisition unit 101 outputs the acquired image information to the space information extraction unit 102a.

Next, the space information extraction unit 102a acquires the image information output from the image information acquisition unit 101. The space information extraction unit 102a performs an image analysis on an image based on the acquired image information, and extracts information such as the position of the base station 20 in the image and the range of the cylindrical Fresnel zone Cz (step S203). The space information extraction unit 102a outputs information including the extracted information and the image information to the propagation loss estimation unit 103a as space information.

The propagation loss estimation unit 103a acquires the space information output from the space information extraction unit 102a. The propagation loss estimation unit 103a obtains an estimated value of the loss amount of the propagation loss due to the shielding rate by inputting the space information acquired from the space information extraction unit 102a to the learned model (step S204). The propagation loss estimation unit 103a outputs information indicating the estimated loss amount of the propagation loss due to the shielding rate to the base station switching determination unit 104.

The base station switching determination unit 104 acquires the information indicating the loss amount of the propagation loss due to the shielding rate output from the propagation loss estimation unit 103a. The base station switching determination unit 104 calculates reception power in the terminal station 10a on the basis of the loss amount based on the acquired information. Then, the base station switching determination unit 104 determines whether or not the calculated value of the reception power is an allowable value (step S205).

When the calculated value of the reception power is an allowable value (step S205: YES), the base station switching determination unit 104 determines that it is not necessary to switch the connection destination to another base station 20. Thus, the operation of the terminal station 10 illustrated in the flowchart of FIG. 14 ends.

On the other hand, when the calculated value of the reception power is not an allowable value (step S205: NO), the base station switching determination unit 104 determines that it is necessary to switch the base station 20 to be the connection destination. In this case, the base station switching determination unit 104 outputs information indicating the base station 20 newly selected as the connection destination to the base station switching control unit 110.

The base station switching control unit 110 acquires information indicating the base station 20 selected as a new connection destination output from the base station selection unit 100a. The base station switching control unit 110 controls the communication unit 120 to switch the base station 20 to be the connection destination on the basis of the acquired information (step S206). Thus, the operation of the terminal station 10 illustrated in the flowchart of FIG. 14 ends.

As described above, the base station selection system 1a according to the modification example of the first embodiment of the present invention appropriately acquires image information indicating an image in which the direction of the base station 20 is captured by the measurement camera 15 installed at substantially the same position as the terminal station 10a. The base station selection system 1a specifies the position of the base station 20 and an image region of a shielding object existing within the range of the cylindrical Fresnel zone Cz from the acquired image. The base station selection system 1a estimates a propagation loss of a radio wave in communication between the terminal station 10a and the base station 20 by inputting information indicating the specified image region and space information including the image information to the learned model. The base station selection system 1 determines whether or not it is necessary to switch the base station 20 to which the terminal station 10a is connected to another base station 20 on the basis of the estimated propagation loss.

With such a configuration, the base station selection system 1a according to the modification example of the first embodiment of the present invention can perform, for example, the line-of-sight determination by using the space information indicating a more immediate situation within the range of the cylindrical Fresnel zone Cz, unlike the conventional line-of-sight determination method in which the number of pieces of point cloud data present between the base station and the terminal station at a certain time point is simply counted. Thus, the base station selection system 1a can more appropriately select the base station 20 to which the terminal station 10a is connected for communication even in a case where the influence of the shielding object on the communication quality changes with time, for example, as in a case where the shielding object is a mobile object such as a vehicle.

Further, with such a configuration, the base station selection system 1a according to the modification example of the first embodiment of the present invention can perform, for example, the line-of-sight determination in consideration of the presence of the shielding object in the entire space within the range of the cylindrical Fresnel zone Cz, unlike the conventional line-of-sight determination method using the point cloud data of only some cross-sections of the Fresnel zone. Thus, the base station selection system 1a can more appropriately select the base station 20 to which the terminal station 10a is connected for communication even in a case where the influence of the shielding object on the communication quality changes depending on the season or the weather, for example, in a case where the covering object is a tree.

Further, with such a configuration, the base station selection system 1a according to the modification example of the first embodiment of the present invention does not calculate the shielding rate on the basis of space information and estimate the propagation loss as in the base station selection system 1 according to the first embodiment described above, but estimates the propagation loss from the space information using the learned model by machine learning. Thus, the base station selection system 1a according to the modification example of the first embodiment can more accurately estimate the propagation loss without simply estimating the same propagation loss even in a case where the shielding rates are equivalent as in the cylindrical Fresnel zone Cz illustrated in FIGS. 10 and 11, for example.

### Second Embodiment

In recent years, in order to widen the communication area, it has been implemented or studied to use an artificial satellite such as a low earth orbiting satellite (LEO), a high altitude platform station (HAPS), or the like as a base station. A base station selection system 1b according to a second embodiment described below uses an imaging device (measurement camera) mounted in such a device flying in the sky (hereinafter referred to as a “flight vehicle”) to determine whether or not it is necessary to switch the base station to which the terminal station is connected for communication.

In the first embodiment and the modification example of the first embodiment described above, the propagation loss is estimated on the basis of the image obtained by capturing the direction of the base station 20 by the measurement camera 15 installed at substantially the same position as the terminal station 10, and it is determined whether or not it is necessary to switch the base station 20 to which the terminal station 10 is connected for communication. On the other hand, the base station selection system 1b according to the second embodiment described below captures an image of a range including a Fresnel zone formed between the terminal station and the base station from above by a measurement camera installed in a flight vehicle. Then, the base station selection system 1b estimates a propagation loss on the basis of an image captured from the sky, and determines whether or not it is necessary to switch the base station to which the terminal station is connected for communication.

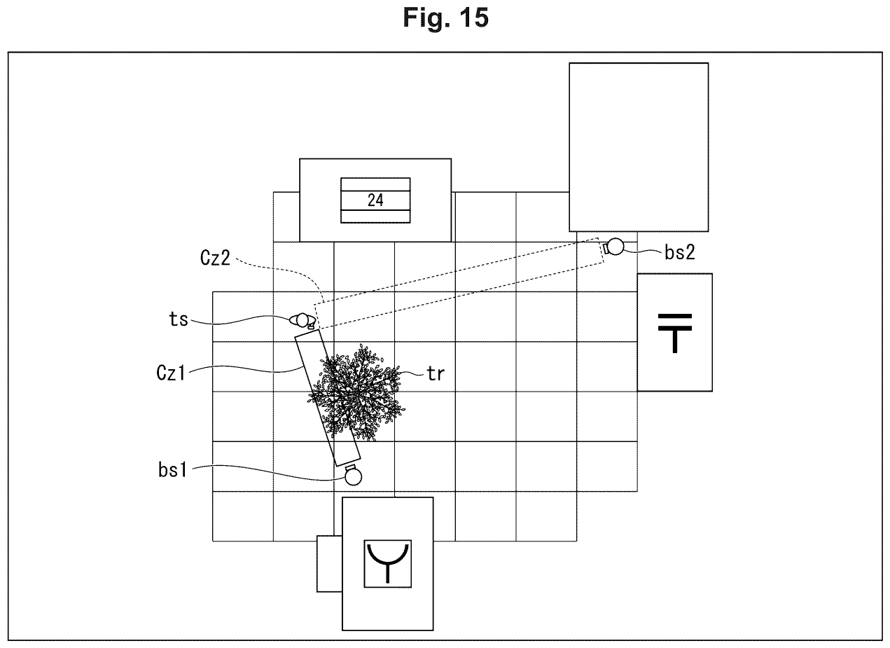

FIG. 15 is a diagram illustrating a state in which the communication environment illustrated in FIG. 4 is viewed from above. As illustrated in FIG. 15, the cylindrical Fresnel zone Cz1 and the cylindrical Fresnel zone Cz2 can be viewed from the direction of the side surface of the cylindrical shape by looking down on the ground from above. As described above, when viewed from the direction of the side surface of the cylindrical shape, it is possible to confirm at which position between the terminal station ts and the base station bs1 (alternatively, between the terminal station ts and the base station bs2) the shielding object (for example, a tree tr, or the like) exists.

That is, for example, it is possible to grasp a situation in which, within the range of the cylindrical Fresnel zone Cz1, shielding objects are concentrated at a position closer to the terminal station ts, shielding objects are concentrated at a position closer to the base station bs, shielding objects are concentrated at a position closer to the center between the terminal station ts and the base station bs, shielding objects are concentrated at each of both a position closer to the terminal station ts and a position closer to the base station bs, or shielding objects are present across the entire range of the cylindrical Fresnel zone Cz1.

### [Overall Configuration of Base Station Selection System]

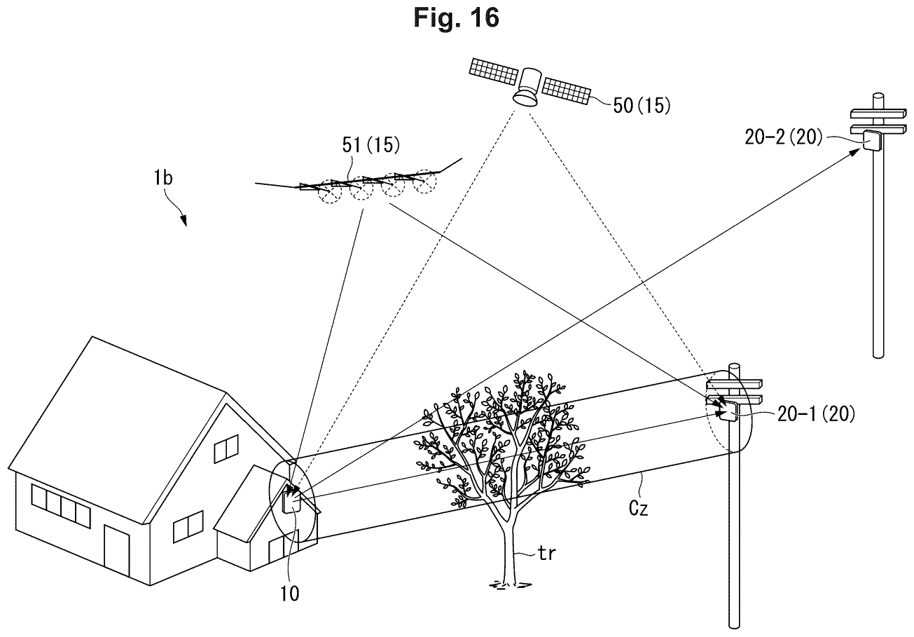

FIG. 16 is a schematic diagram illustrating an overall configuration of the base station selection system 1b according to the second embodiment of the present invention. FIG. 16 illustrates a low-rise house in which the terminal station 10 is attached to a wall surface, a utility pole to which the base station 20-1 is attached, a utility pole to which the base station 20-2 is attached, and a low earth orbiting satellite 50 (LEO) and a high altitude platform station 51 (HAPS) which are flying vehicles flying in the sky. The measurement camera 15 (not illustrated) is attached to each of the low earth orbiting satellite 50 and the high altitude platform station 51. Further, FIG. 16 illustrates a cylindrical Fresnel zone Cz approximating the Fresnel zone formed between the base station 20-1 and the terminal station 10.

Note that, although each of the low earth orbiting satellite 50 and the high altitude platform station 51 is illustrated in FIG. 16, in the base station selection system 1b according to the second embodiment, the roles of the low earth orbiting satellite and the high altitude platform station 51 are the same, and thus it is sufficient if at least one of the low earth orbiting satellite 50 or the high altitude platform station is provided. In the following description, a case where the low earth orbiting satellite 50 is used will be described as an example, but the high altitude platform station 51 may be used instead. Note that, unlike the first embodiment and the modification example of the first embodiment described above, no measurement camera is installed near the terminal station 10.

As illustrated in FIG. 16, a tree tr is planted between the base station 20-1 and the terminal station 10. Then, a part of the tree tr is within the range of the cylindrical Fresnel zone Cz. Therefore, in a case where the terminal station 10 is connected for communication to the base station 20-1, there is a possibility that the tree tr influences the quality of wireless communication (that is, degrades the communication quality) performed between the terminal station 10 and the base station 20-1 to no small extent.

As described above, the measurement camera 15 (not illustrated) is attached to the low earth orbiting satellite 50. For example, the measurement camera 15 captures an image every time the low earth orbiting satellite 50 passes over the Fresnel zone. Note that, in a case where the above-described high altitude platform station 51 is used, the measurement camera 15 may capture images periodically (for example, every minute). The measurement camera 15 transmits image information indicating an image obtained by image-capturing to the terminal station 10.

### [Functional Configuration of Base Station Selection System]

The functional configuration of the base station selection system 1b according to the second embodiment is basically similar to the functional configuration of the base station selection system 1 according to the first embodiment illustrated in the block diagram of FIG. 7 described above. The functional configuration of the base station selection system 1b is different from the functional configuration of the base station selection system 1 in that the measurement camera 15 is provided not near the terminal station 10 but in the low earth orbiting satellite 50 (alternatively, the high altitude platform station 51) that flies in the sky.

The shape of the range of the cylindrical Fresnel zone Cz extracted from the image by the space information extraction unit 102 varies depending on the difference in the position of the measurement camera 15 as described above. That is, in the first embodiment, for example, as illustrated in FIGS. 6, 10, and 11, the shape of the cylindrical Fresnel zone Cz in a planar image is circular. On the other hand, in the second embodiment, since imaging-capturing is performed from the direction of the side surface of the cylindrical Fresnel zone Cz, the shape of the cylindrical Fresnel zone Cz in a planar image is square (for example, rectangular) as described later.

For example, the propagation loss estimation unit 103 calculates, as the shielding rate, a ratio of an area of an image region in which a shielding object is captured to an area of a square that is the range of the cylindrical Fresnel zone Cz in a planar image.

Note that the functional configuration of the base station selection system 1b according to the second embodiment may be basically similar to the functional configuration of the base station selection system 1a according to the modification example of the first embodiment illustrated in the block diagram of FIG. 12 described above. Also in this case, the functional configuration of the base station selection system 1b is different from the functional configuration of the base station selection system 1a in that the measurement camera 15 is provided not near the terminal station 10 but in the low earth orbiting satellite 50 (alternatively, the high altitude platform station 51) flying in the sky.

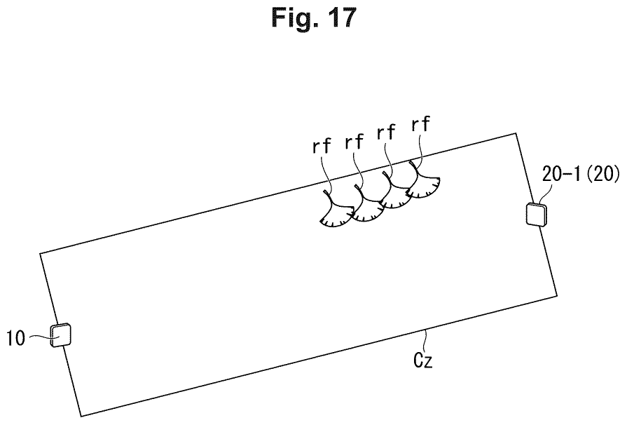

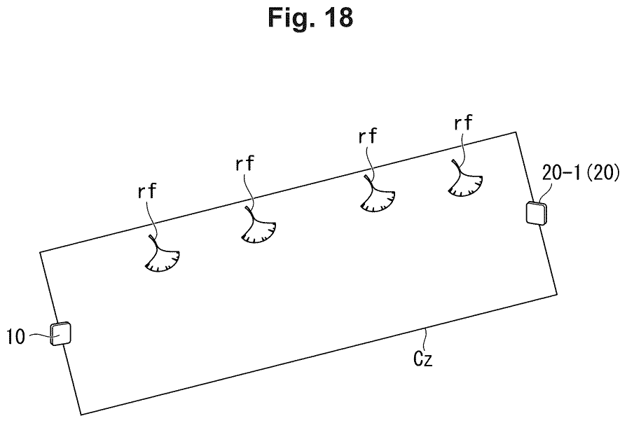

Note that, as illustrated in FIGS. 17 and 18, the shape of the cylindrical Fresnel zone Cz in a planar image captured by the measurement camera 15 is square. Even if the shielding rate is the same within this rectangular range, there are various cases of positions where the shielding object may exist.

For example, in the cylindrical Fresnel zone Cz illustrated in FIG. 17, leaves rf are biased to a part of a rectangular range of the cylindrical Fresnel zone Cz. Specifically, in the cylindrical Fresnel zone Cz illustrated in FIG. 17, the leaves rf are densely present at a position closer to the base station 20-1 than the terminal station 10 and at an upper position in the drawing.

On the other hand, for example, in the cylindrical Fresnel zone Cz illustrated in FIG. 18, leaves rf are present unevenly at an upper position in the drawing, but unlike the cylindrical Fresnel zone Cz illustrated in FIG. 17, there is relatively no unevenness between the terminal station 10 and the base station 20-1, and the leaves rf are evenly present.

Thus, the positions of the shielding objects within the range of the cylindrical Fresnel zone Cz illustrated in FIG. 17 are different from the positions of the shielding objects within the range of the cylindrical Fresnel zone Cz illustrated in FIG. 18. However, if the measurement camera 15 is installed at substantially the same position as the terminal station 10 as in the first embodiment and the modification example of the first embodiment described above, the positions of the shielding objects in the captured image are substantially the same in both cases. Specifically, in both cases, the positions of the shielding objects will be as the positions of the leaves rf within the range of the cylindrical Fresnel zone Cz illustrated in FIG. 10 described above.

The shielding rate in the range of the cylindrical Fresnel zone Cz illustrated in FIG. 17 and the shielding rate in the range of the cylindrical Fresnel zone Cz illustrated in FIG. 18 are considered to be substantially the same, but it is also considered that a large difference occurs in the values of the propagation loss based on the shielding rate. Specifically, in the case of FIG. 17, since the leaves rf exist more densely, it is expected that the value of the propagation loss becomes larger.

As described above, since it is assumed that the values of the propagation loss may be different even if the shielding rates are equivalent values, it is considered that the necessity of switching of the base station 20 to which the terminal station 10 is connected for communication can be determined more accurately by estimating the propagation loss from the space information using a learned model by machine learning as in the base station selection system 1a according to the modification example of the first embodiment described above, instead of estimating the propagation loss by calculating the shielding rate on the basis of the space information as in the base station selection system 1 according to the first embodiment described above.

### [Operations of Terminal Station and Learning Device]

The operation of the terminal station 10 according to the second embodiment is basically similar to the operation of the terminal station 10 according to the first embodiment illustrated in the flowchart of FIG. 8 described above or the operation of the terminal station 10 according to the modification example of the first embodiment illustrated in the flowchart of FIG. 14 described above. Furthermore, the operation of the learning device 30 according to the second embodiment is basically similar to the operation of the learning device 30 according to the modification example of the first embodiment illustrated in the flowchart of FIG. 13 described above.

As described above, the base station selection system 1b according to the second embodiment of the present invention appropriately acquires, by the measurement camera 15 installed on the low earth orbiting satellite 50 (alternatively, the high altitude platform station 51) flying in the sky, image information indicating an image obtained by capturing at least the range of the cylindrical Fresnel zone Cz formed in the communication between the terminal station 10 and the base station 20. The base station selection system 1b specifies the position of the terminal station 10, the position of the base station 20, and the image region of the shielding object existing within the range of the cylindrical Fresnel zone Cz from the acquired image.

The base station selection system 1b calculates the shielding rate of the cylindrical Fresnel zone Cz from the image region of the specified shielding object, and estimates the propagation loss of the radio wave in the communication between the terminal station 10 and the base station 20 on the basis of the calculated shielding rate. The base station selection system 1 determines whether or not it is necessary to switch the base station 20 to which the terminal station 10 is connected to another base station 20 on the basis of the estimated propagation loss.

Alternatively, the base station selection system 1b estimates the propagation loss of the radio wave in the communication between the terminal station 10 and the base station 20 by inputting the information indicating the specified image region and the space information including the image information to the learned model. The base station selection system 1 determines whether or not it is necessary to switch the base station 20 to which the terminal station 10 is connected to another base station 20 on the basis of the estimated propagation loss.

With such a configuration, the base station selection system 1b according to the second embodiment of the present invention can perform, for example, the line-of-sight determination by using the space information indicating a more immediate situation within the range of the cylindrical Fresnel zone Cz, unlike the conventional line-of-sight determination method in which the number of pieces of point cloud data present between the base station and the terminal station at a certain time point is simply counted. Thus, the base station selection system 1b can more appropriately select the base station 20 to which the terminal station 10 is connected for communication even in a case where the influence of the shielding object on the communication quality changes with time as in a case where, for example, the shielding object is a mobile object such as a vehicle.

Furthermore, with such a configuration, the base station selection system 1b according to the second embodiment of the present invention can perform, for example, the line-of-sight determination in consideration of the presence of the shielding object in the entire space within the range of the cylindrical Fresnel zone Cz, unlike the conventional line-of-sight determination method using the point cloud data of only some cross-sections of the Fresnel zone. Thus, the base station selection system 1b can more appropriately select the base station 20 to which the terminal station 10 is connected for communication even in a case where the influence of the shielding object on the communication quality changes depending on the season or the weather, for example, as in a case where the covering object is a tree.

Further, since the base station selection system 1b according to the second embodiment of the present invention includes the configuration for estimating the propagation loss from the space information using the learned model by machine learning, even in a case where, for example, the shielding rates are equivalent as in the cylindrical Fresnel zone Cz illustrated in FIGS. 17 and 18, the propagation loss can be estimated more accurately without simply estimating the same propagation loss.

Furthermore, the base station selection system 1b according to the second embodiment of the present invention does not use an image captured by the measurement camera 15 installed at a position near the terminal station 10 as in the first embodiment and the modification example of the first embodiment described above, but uses an image captured by the measurement camera 15 installed on the low earth orbiting satellite 50 (alternatively, the high altitude platform station 51) flying in the sky. Thus, the base station selection system 1b according to the second embodiment can obtain more information regarding the position of the shielding object within the range of the cylindrical Fresnel zone Cz, so that the propagation loss can be estimated more accurately, and whether or not it is necessary to switch the base station 20 to which the terminal station 10 is connected to another base station 20 can be determined more accurately.

### Third Embodiment

In the first embodiment and the modification example of the first embodiment described above, whether or not it is necessary to switch the base station 20 to which the terminal station 10 is connected to another base station 20 is determined on the basis of the image captured by the measurement camera 15 installed at the position near the terminal station 10. On the other hand, in the second embodiment described above, it is configured to determine whether or not it is necessary to switch the base station 20 to which the terminal station 10 is connected to another base station 20 on the basis of the image captured by the measurement camera 15 installed in the low earth orbiting satellite 50 (alternatively, the high altitude platform station 51) flying in the sky.

If both the above images can be used, the three-dimensional position of each shielding object within the range of the cylindrical Fresnel zone Cz can be specified. In this way, if both images can be used, it is considered that the accuracy of estimating the propagation loss of the radio wave in the communication between the terminal station 10 and the base station 20 becomes higher.

### [Overall Configuration of Base Station Selection System]

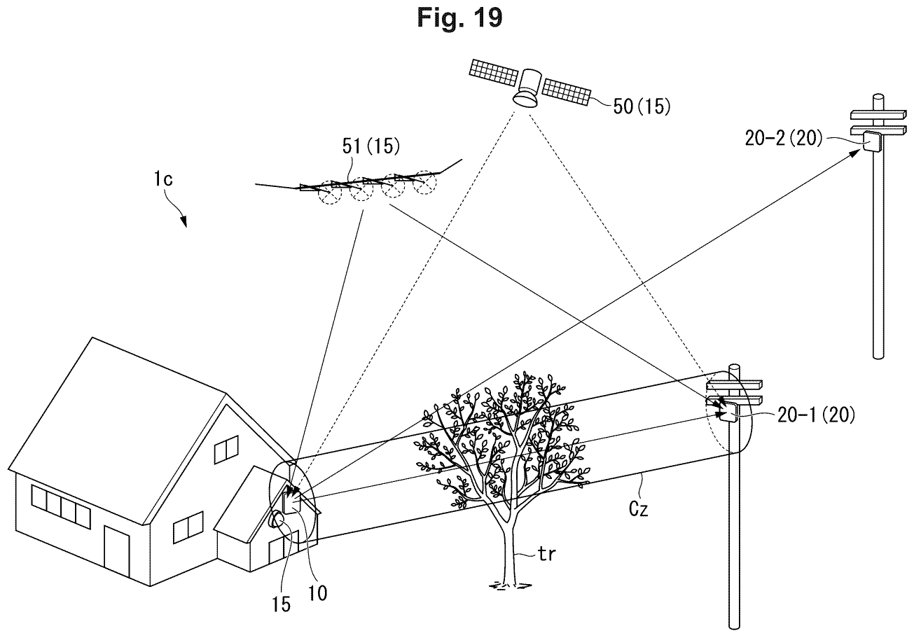

FIG. 19 is a schematic diagram illustrating an overall configuration of the base station selection system 1c according to a third embodiment of the present invention. FIG. 19 illustrates a low-rise house in which the terminal station 10 and the measurement camera 15 are attached to a wall surface, a utility pole to which the base station 20-1 is attached, a utility pole to which the base station 20-2 is attached, and the low earth orbiting satellite 50 (LEO) and the high altitude platform station 51 (HAPS) which are flying vehicles flying in the sky. The measurement camera 15 (not illustrated) is attached to each of the low earth orbiting satellite 50 and the high altitude platform station 51. Further, FIG. 19 illustrates the cylindrical Fresnel zone Cz approximating the Fresnel zone formed between the base station 20-1 and the terminal station 10.

Note that, although each of the low earth orbiting satellite 50 and the high altitude platform station 51 is illustrated in FIG. 19, in the base station selection system 1c according to the third embodiment, the roles of the low earth orbiting satellite 50 and the high altitude platform station 51 are the same, and thus it is sufficient if at least one of them is provided. Note that, as in the first embodiment and the modification example of the first embodiment described above, the measurement camera 15 is also installed near the terminal station 10.

As illustrated in FIG. 16, the tree tr is planted between the base station 20-1 and the terminal station 10. Then, a part of the tree tr is within the range of the cylindrical Fresnel zone Cz. Therefore, in a case where the terminal station 10 is connected for communication to the base station 20-1, there is a possibility that the tree tr influences the quality of wireless communication (that is, degrades the communication quality) performed between the terminal station 10 and the base station 20-1 to no small extent.

As described above, the measurement camera 15 (not illustrated) is attached to the low earth orbiting satellite 50. For example, the measurement camera 15 captures an image every time the low earth orbiting satellite 50 passes over the Fresnel zone. Note that, in a case where the above-described high altitude platform station 51 is used, the measurement camera 15 may capture images periodically (for example, every minute). The measurement camera 15 transmits image information indicating an image obtained by image-capturing to the terminal station 10.

The terminal station 10 determines whether or not it is necessary to switch the base station 20 to which the terminal station 10 is connected to another base station 20 on the basis of both an image captured by the measurement camera 15 installed at a position near its own terminal station 10 and an image captured by the measurement camera 15 installed in the low earth orbiting satellite 50 (alternatively, the high altitude platform station 51) flying in the sky.

With the above configuration, the base station selection system 1c according to the third embodiment can more accurately estimate the propagation loss of the radio wave in the communication between the terminal station 10 and the base station 20 as compared with the base station selection system 1 according to the first embodiment described above, the base station selection system 1a according to the modification example of the first embodiment described above, and the base station selection system 1b according to the second embodiment described above. Thus, the base station selection system 1c according to the third embodiment can more accurately determine whether or not it is necessary to switch the base station 20 to which the terminal station 10 is connected to another base station 20.

Note that, in each of the above-described embodiments, for example, three-dimensional point cloud data obtained by an MMS may be further used to determine whether or not it is necessary to switch the base station 20 to which the terminal station 10 is connected to another base station 20.

For example, the propagation loss estimation unit 103 illustrated in FIG. 7 described above may estimate the propagation loss in consideration of both the shielding rate (hereinafter referred to as a “shielding rate based on an image”) calculated on the basis of the image captured by the measurement camera 15 and the shielding rate (hereinafter referred to as a “shielding rate based on the point cloud data”) calculated on the basis of the point cloud data.

In this case, in order to obtain the shielding rate based on the point cloud data, in addition to the measurement camera 15 (alternatively, instead of the measurement camera 15), the base station selection systems 1 and 1a to 1c include, for example, a laser radar (also referred to as “Light Detection And Ranging (LiDAR)”) that generates point cloud data by measuring the position of an object. Further, in this case, the base station selection units 100 and 100a of the base station selection systems 1 and 1a to 1c includes, for example, a point cloud data acquisition unit that acquires the generated point cloud data in addition to the image information acquisition unit 101 (alternatively, instead of the image information acquisition unit 101).

Specifically, for example, the propagation loss estimation unit 103 may estimate the propagation loss on the basis of an average value of the shielding rate based on the image and the shielding rate based on the point cloud data. Alternatively, for example, the propagation loss estimation unit 103 may estimate the propagation loss on the basis of a larger value of the shielding rate based on the image and the shielding rate based on the point cloud data. Alternatively, for example, the propagation loss estimation unit 103 may estimate the propagation loss on the basis of a smaller value of the shielding rate based on the image and the shielding rate based on the point cloud data.

Furthermore, for example, the propagation loss estimation unit 103a illustrated in FIG. 12 described above may further input three-dimensional point cloud data (alternatively, information based on the point cloud data) obtained by the MMS to the learned model in addition to the space information acquired from the space information extraction unit 102a to obtain an estimated value of the loss amount of the propagation loss due to the shielding rate.

In this case, the teacher data acquisition unit 301 further acquires a large amount of teacher data including three-dimensional point cloud data (alternatively, information based on the point cloud data) from an external device. The teacher data mentioned here is information in which space information indicating a situation of a space within the range of the cylindrical Fresnel zone Cz actually generated, three-dimensional point cloud data (alternatively, information based on the point cloud data), and information indicating a propagation loss of a radio wave actually generated in communication between the terminal station 10a and the base station 20 in the situation form one set. The teacher data acquisition unit 301 outputs the teacher data to the learning unit 302.

Note that the teacher data acquisition unit 301 may further use, as the teacher data, information in which the actual space information output from the space information extraction unit 102a and the information indicating the actual propagation loss output from the base station 20 form one set.

The learning unit 302 acquires the teacher data output from the teacher data acquisition unit 301. The learning unit 302 performs machine learning using the space information included in the teacher data, the point cloud data (alternatively, information based on the point cloud data), and the information indicating the propagation loss as inputs. Note that, as described above, the space information includes, for example, the space information including information such as the position of the base station 20 and the range of the cylindrical Fresnel zone Cz, and the image information. The learning unit 302 outputs the learned model generated by performing machine learning to the learned model transmission unit 303.

The learned model transmission unit 303 acquires the learned model output from the learning unit 302. The learned model transmission unit 303 transmits the acquired learned model to the propagation loss estimation unit 103a.

As described above, by employing the configuration in which the propagation loss estimation unit 103a further inputs three-dimensional point cloud data (alternatively, information based on the point cloud data) to the learned model in addition to the space information, it is considered that the loss amount of the propagation loss due to the shielding rate can be calculated more accurately. Thus, it is considered that it is possible to more accurately determine whether or not it is necessary to switch the base station 20 to which the terminal station 10 is connected to another base station 20.

According to the above-described embodiment, the radio station selection system includes an acquisition unit, an estimation unit, and a determination unit. For example, the radio station selection system is the base station selection system 1 according to the embodiment, the acquisition unit is the image information acquisition unit 101 according to the embodiment, the estimation unit is the propagation loss estimation unit 103 according to the embodiment, and the determination unit is the base station switching determination unit 104 according to the embodiment.

The acquisition unit described above acquires image information indicating an image obtained by capturing a space through which radio waves can propagate in communication between a first radio station and a second radio station. For example, the first radio station is the terminal station 10 according to the embodiment, the second radio station is the base station 20-1 according to the embodiment, and the space through which radio waves can propagate is the Fresnel zone according to the embodiment. The estimation unit described above estimates a propagation loss of a radio wave in the communication on the basis of the image information acquired by the acquisition unit. The determination unit described above determines whether or not to switch the radio station to which the first radio station is connected for communication from the second radio station to a third radio station on the basis of the propagation loss estimated by the estimation unit. For example, the third radio station is the base station 20-1 according to the embodiment.

Note that the radio station selection system described above may further include a learning unit. For example, the radio station selection system is the base station selection system 1a according to the embodiment, and the learning unit is the learning unit 302 according to the embodiment. The learning unit described above performs machine learning using teacher data including the image information and the propagation loss and generates a learned model. In this case, the estimation unit estimates the propagation loss by inputting the image information acquired by the acquisition unit to the learned model generated by the learning unit.

Note that, in the radio station selection system described above, the space is a Fresnel zone formed in communication between the first radio station and the second radio station, or a cylindrical space approximate to the Fresnel zone. For example, the Fresnel zone is the Fresnel zone fz according to the embodiment, and the cylindrical space approximate to the Fresnel zone is the cylindrical Fresnel zone Cz according to the embodiment.

Note that, in the radio station selection system described above, the image may be an image obtained by capturing a direction of the second radio station from a position of the first radio station. For example, the image obtained by capturing the direction of the second radio station from the position of the first radio station is an image captured by the measurement camera 15 installed near the terminal station 10 according to the embodiment.

Note that, in the radio station selection system described above, the image may be an image captured from above the space. For example, the radio station selection system is the base station selection system 1b according to the embodiment.

Note that, in the radio station selection system described above, the image may be an image including both an image obtained by capturing a direction of the second radio station from a position of the first radio station and an image captured from above the space.

Note that, in the radio station selection system described above, the image may be an image captured by an imaging device mounted on a low earth orbiting satellite or a high altitude platform station. For example, the low earth orbiting satellite is the low earth orbiting satellite 50 according to the embodiment, the high altitude platform station is the high altitude platform station 51 according to the embodiment, and the imaging device is the measurement camera 15 (not illustrated) installed in the low earth orbiting satellite 50 or the high altitude platform station 51 according to the embodiment.

A part of the base station selection systems 1 and 1a to 1c in each of the above-described embodiments may be implemented by a computer. In that case, a program for implementing the functions may be recorded in a computer-readable recording medium, and the program recorded in the recording medium may be read and executed by a computer system to implement the functions. Note that the “computer system” mentioned herein includes an OS and hardware such as peripheral devices. In addition, the “computer-readable recording medium” is a portable medium such as a flexible disk, a magneto-optical disc, a ROM, or a CD-ROM, or a storage device such as a hard disk incorporated in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, specific configurations are not limited to the embodiments and include design and the like within the scope of the present invention without departing from the gist of the present invention.

### REFERENCE SIGNS LIST

1, 1a, 1b, 1c Base station selection system
10, 10a Terminal station
15 Measurement camera
20, 20-1, 20-2 Base station
30 Learning device
50 Low earth orbiting satellite
51 High altitude platform station
100, 100a Base station selection unit
101 Image information acquisition unit
102, 102a Space information extraction unit
103, 103a Propagation loss estimation unit
104 Base station switching determination unit
110 Base station switching control unit
120 Communication unit
301 Teacher data acquisition unit
302 Learning unit
303 Learned model transmission unit

1. A radio station selection method comprising:
an acquisition step of acquiring image information indicating an image obtained by capturing a space through which a radio wave is able to propagate in communication between a first radio station and a second radio station;
an estimation step of estimating a propagation loss of a radio wave in the communication on a basis of the image information acquired in the acquisition step; and
a determination step of determining whether or not to switch a radio station to which the first radio station is connected for communication from the second radio station to a third radio station on a basis of the propagation loss estimated in the estimation step.

2. The radio station selection method according to claim 1, further comprising:
a learning step of performing machine learning using teacher data including the image information and the propagation loss and generating a learned model, wherein
in the estimation step, the propagation loss is estimated by inputting the image information acquired in the acquisition step to the learned model generated in the learning step.

3. The radio station selection method according to claim 1, wherein
the space is a Fresnel zone formed in communication between the first radio station and the second radio station, or a cylindrical space approximate to the Fresnel zone.

4. The radio station selection method according to claim 1, wherein
the image is an image obtained by capturing a direction of the second radio station from a position of the first radio station.

5. The radio station selection method according to claim 1, wherein
the image is an image captured from above a space.

6. The radio station selection method according to claim 1, wherein
the image includes both an image obtained by capturing a direction of the second radio station from a position of the first radio station and an image captured from above a space.

7. The radio station selection method according to claim 5, wherein
the image is an image captured by an imaging device mounted on a low earth orbiting satellite or a high altitude platform station.

8. A radio station selection system comprising:
a processor; and
a storage medium having computer program instructions stored thereon, when executed by the processor, perform to:
acquires image information indicating an image obtained by capturing a space through which a radio wave is able to propagate in communication between a first radio station and a second radio station;
estimates a propagation loss of a radio wave in the communication on a basis of the image information; and
determines whether or not to switch a radio station to which the first radio station is connected for communication from the second radio station to a third radio station on a basis of the propagation loss.
